(19) United States
(12) Patent Application Publication
(10) Pub. No.: US 2026/0289162 A1
(43) Pub. Date: Sep. 24, 2026

(54) SYSTEM

(71) Applicant: SoftBank Group Corp., Tokyo (JP)

(72) Inventor: Taku KIKUCHI, Tokyo (JP)

(73) Assignee: SoftBank Group Corp., Tokyo (JP)

(21) Appl. No.: 19/561,721

(22) Filed: Mar. 10, 2026

(30) Foreign Application Priority Data
Mar. 19, 2025 (JP) 2025-044509

(51) Int. Cl. G06F 40/40; G06F 40/205; G06N 3/0475; G06Q 10/0633

(52) U.S. Cl. CPC G06F 40/40; G06F 40/205; G06N 3/0475; G06Q 10/0633

(57) ABSTRACT

A system includes a processor that is configured to receive information input from a user, visualize the information, track the information over time, detect an abnormality in the information, identify a factor causing the abnormality, execute, on an application program on which artificial intelligence is applicable, processing for formulating a countermeasure based on the identified factor, recognize an emotion of the user, identify an emotional state of the user based on the recognized emotion, and perform an appropriate response according to the identified emotional state of the user.

### CROSS-REFERENCE TO RELATED APPLICATION

This application is based on and claims priority under 35 USC 119 from Japanese Patent Application No. 2025-044509 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional business management and information processing systems are generally limited to functions such as receiving user input, displaying information, and performing simple statistical analysis. Such systems do not adequately support an integrated workflow including visualization of user-input information, time-series tracking, abnormality detection, root cause identification, and systematic countermeasure formulation on a single platform. In particular, conventional systems do not effectively leverage artificial intelligence to automatically execute this series of processes at a speed and scale that exceed human capability.

Furthermore, existing systems rarely consider the emotional state of the user when presenting analysis results or proposing countermeasures. As a result, the system may provide information or recommendations in a manner that is inappropriate for the user's current emotional state, which can reduce user acceptance, impede decision-making, and lower overall operational effectiveness.

In addition, even when artificial intelligence is employed, conventional systems often do not provide adequate means for supplying domain-specific knowledge, experience, and skills to generative artificial intelligence. Consequently, the quality and accuracy of generated countermeasures and explanations remain limited, and the system cannot continuously improve based on new data and user feedback.

Accordingly, there is a need for a system that, on an application program on which artificial intelligence is applicable, can: receive user-input information; visualize and track that information; detect abnormalities; identify root causes; formulate countermeasures using artificial intelligence, including generative artificial intelligence and machine learning algorithms; and, at the same time, recognize and understand a user's emotional state to provide an appropriate response in accordance with that emotional state.

### SUMMARY

In order to solve the above-described problems, an embodiment of the present invention provides a system comprising a processor, wherein the processor is configured to receive information input from a user, visualize the information, track the information over time, detect an abnormality in the information, identify a factor causing the abnormality, and execute, on an application program on which artificial intelligence is applicable, processing for formulating a countermeasure based on the identified factor. By integrating these functions, the processor enables an end-to-end workflow from data acquisition to countermeasure formulation within a single system, thereby improving the speed and accuracy of business management and decision-making.

In the system according to one embodiment, the processor is further configured to recognize an emotion of the user, identify an emotional state of the user based on the recognized emotion, and perform an appropriate response according to the identified emotional state of the user. For example, the processor can adjust the level of detail, tone, or timing of information presentation and countermeasure proposals based on whether the user is in a calm, stressed, or confused emotional state, thereby improving user acceptance and usability.

In another embodiment, the artificial intelligence comprises a generative artificial intelligence, and the system further comprises a means for providing knowledge, experience, and skills required by the generative artificial intelligence. By providing domain-specific data, expert knowledge, and operational know-how to the generative artificial intelligence, the system enables the artificial intelligence to generate more accurate, context-aware countermeasures and explanations tailored to the user's environment and industry.

In a further embodiment, the processor is configured to apply a machine learning algorithm when formulating the countermeasure using the artificial intelligence, and to improve an accuracy of the formulated countermeasure based on results of the machine learning algorithm. For example, the processor can learn from historical cases of abnormalities and corresponding successful countermeasures, update internal models, and refine future countermeasure proposals. Through this configuration, the system continually enhances its performance over time and provides highly reliable and effective support for business management and operational decision-making.

The term “system” refers to an information processing apparatus, which may be implemented as one or more physical or virtual machines, configured to execute the functions described herein.

The term “processor” refers to one or more hardware processing units, such as a central processing unit (CPU), graphics processing unit (GPU), digital signal processor (DSP), microcontroller, or any combination thereof, that execute instructions to perform the claimed operations.

The term “information input from a user” refers to any data, command, parameter, or content provided by a human operator via an input device or interface, including but not limited to text input, numerical values, selections from a graphical user interface, voice input, sensor-based input, or uploaded files.

The term “visualize the information” refers to processing the information input from a user or derived therefrom to generate a representation that can be perceived by the user, such as charts, graphs, tables, dashboards, diagrams, or other graphical or textual displays.

The term “track the information over time” refers to recording and maintaining a history of the information or metrics derived from the information, associating the information with timestamps or sequence identifiers, and enabling retrieval or analysis of how the information changes over time.

The term “detect an abnormality in the information” refers to identifying a state or value of the information that deviates from a reference condition, such as a threshold, normal range, historical pattern, or model-predicted behavior, by means of rule-based logic, statistical analysis, or machine learning.

The term “factor causing the abnormality” refers to one or more variables, conditions, events, or features that are determined to contribute to or be associated with the occurrence of the detected abnormality.

The term “formulating a countermeasure” refers to generating, selecting, or recommending one or more actions, parameter changes, process adjustments, or operational instructions that are intended to reduce, eliminate, or mitigate the detected abnormality or its effects.

The term “application program on which artificial intelligence is applicable” refers to a software application, running on the system, that is designed or configured to incorporate artificial intelligence functions, such as model inference, learning, reasoning, or generative processing, to perform one or more of the claimed operations.

The term “artificial intelligence” refers to a computational function or system that performs tasks typically requiring human intelligence, including but not limited to pattern recognition, prediction, decision-making, natural language processing, anomaly detection, and generation of recommendations, using techniques such as machine learning, deep learning, rule-based reasoning, or generative models.

The term “generative artificial intelligence” refers to an artificial intelligence model or system capable of generating new content or outputs, such as text, recommendations, explanations, or countermeasure proposals, based on learned patterns from training data, including but not limited to large language models and other generative models.

The term “means for providing knowledge, experience, and skills required by the generative artificial intelligence” refers to hardware and/or software components configured to supply the generative artificial intelligence with domain-specific data, training datasets, expert annotations, rules, models, or other information that enable the generative artificial intelligence to perform domain-appropriate and context-aware processing.

The term “machine learning algorithm” refers to a computational procedure that automatically learns patterns, parameters, or decision rules from data, without being explicitly programmed for each decision, including but not limited to supervised learning, unsupervised learning, reinforcement learning, and ensemble methods.

The term “recognize an emotion of the user” refers to detecting or estimating an emotional state or affective condition of the user, such as happiness, frustration, stress, confusion, or calmness, by analyzing signals such as user input, voice characteristics, facial expressions, physiological data, textual content, or interaction patterns.

The term “emotional state of the user” refers to a representation or classification of the user's current emotional or affective condition, which may be expressed as categories, scores, or continuous values, derived from recognized emotions.

The term “perform an appropriate response according to the identified emotional state of the user” refers to adjusting the system's behavior, including but not limited to the style, timing, content, or level of detail of information presentation, feedback, or countermeasure proposals, in a manner that is determined to be suitable or beneficial given the identified emotional state.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

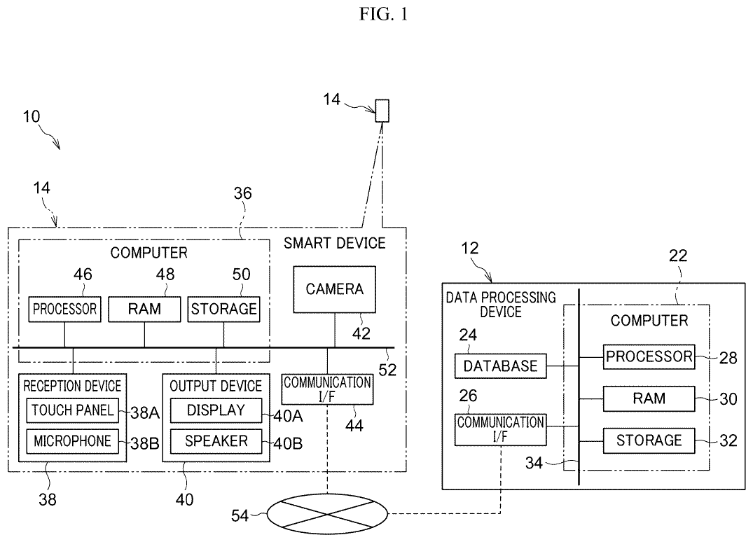

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

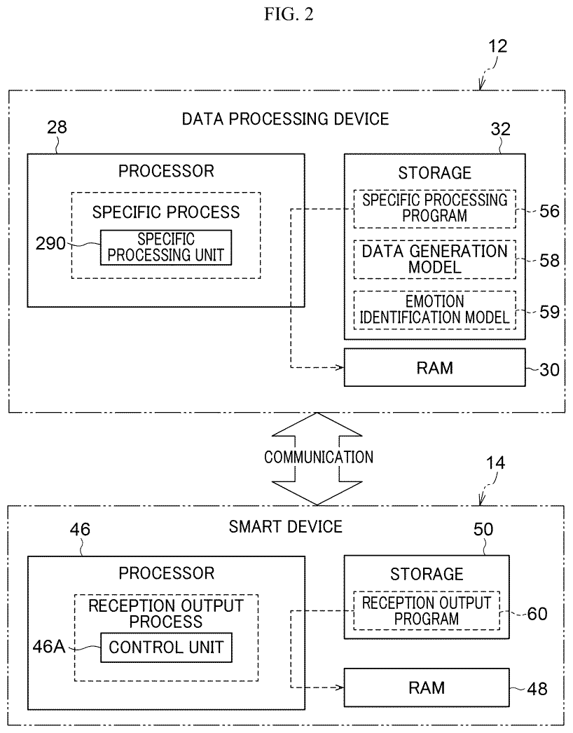

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented business management systems typically perform data collection, visualization, and rule-based alerting using separate, loosely integrated software components. In such systems, a processor may acquire time-series data from sensors and databases, render static dashboards, and raise simple threshold-based alarms. However, these systems face significant technical limitations when they attempt to (i) detect complex anomalies in large-scale, heterogeneous time-series data, (ii) identify root causes with sufficient precision to support automated decision making, and (iii) compute and present optimized countermeasures in a form that is usable by human operators in real time.

First, with respect to anomaly detection and tracking, existing systems often treat time-series storage, model execution, and visualization as independent subsystems. As the volume and dimensionality of incoming data increase, these systems suffer from increased latency and reduced detection accuracy, because the processor does not maintain a tightly coupled feedback loop between temporal tracking, feature generation, model adaptation, and alert generation. As a result, the computing resources of the processor and the associated storage devices are not used efficiently, and the system fails to exploit temporal context and historical patterns in a computationally effective manner.

Second, root-cause analysis and countermeasure formulation are typically performed offline or manually, outside of the core data-processing pipeline. Even when machine-learning models or simulation tools are used, they are often run as separate applications without systematic integration into the main processor-controlled workflow. This architecture leads to fragmented data flows, redundant computation, and difficulties in maintaining consistency between anomaly detection logic, causal inference logic, and optimization logic. Consequently, the processor cannot dynamically adapt simulation parameters or optimization constraints based on newly detected anomalies or updated historical information, which degrades the technical performance of the overall system.

Third, when the system attempts to present analysis results and countermeasures to users, the interaction is generally limited to static textual messages or generic dashboards. The processor does not adapt the form or content of the output based on a detected emotional state of the user or on structured summaries of the internal model state. As a result, the interface layer between the core computation and the human operator does not effectively support rapid understanding or trust in the system's outputs, which in turn reduces the efficiency with which the user can guide subsequent computational processes.

Fourth, generative artificial intelligence models have recently been introduced as external services that can generate natural language reports. However, in many implementations, the processor merely forwards raw data or free-form prompts to such models, without a structured mechanism for: (i) constructing prompt sentences from internal anomaly, cause, and optimization summaries; (ii) integrating natural-language output back into the processing pipeline; and (iii) using user feedback on that output to refine subsequent prompts and computational parameters. This lack of tight integration limits the ability of the system to leverage generative models as part of a closed computational loop, and leads to inefficient use of computing resources, network bandwidth, and model inference cycles.

Accordingly, there is a need for a computer-implemented system in which a processor is specifically configured to execute, under unified control, a sequence of operations that include temporal tracking, anomaly detection, cause identification, simulation-based and optimization-based countermeasure computation, and adaptive user interaction. There is a further need to technically integrate a generative artificial intelligence model into this sequence in such a way that the processor automatically generates structured prompt sentences, obtains natural-language explanations and proposals, and uses user feedback to update both internal models and subsequent prompts. By addressing these issues as computer-technology problems, the invention aims to improve the functioning of the processor itself, including improved utilization of memory and storage, reduced latency and computational redundancy, and enhanced reliability and interpretability of model-driven outputs in a complex, time-series analysis environment.

The specific processing by the specific processing unit 290 of the data processing device 12 in Example 1 is realized by the following means.

The present invention provides a server comprising a processor configured to receive information input from a user; visualize the received information as a graphical representation; record and track temporal changes of the received information and measurement values based on the received information in a time-series data store under control of the processor; detect an anomaly in the tracked data by executing, with the processor, statistical processing and learning processing on a data set including the temporal changes; extract, by the processor, context information related to the detected anomaly from at least one storage device and specify a cause of the anomaly based on integrated information including the context information; set, as changeable parameters in a memory accessible by the processor, control variables and operation conditions related to the specified cause, and perform, by executing program code, a simulation process that simulates behavior when the parameters are varied; construct, by the processor, an optimization problem by defining an objective function and constraint conditions using a result of the simulation process, and calculate a countermeasure plan by solving the optimization problem through an optimization algorithm executed by the processor; generate, by the processor, explanation information that presents the countermeasure plan in a human-interpretable form and output the explanation information via an output interface to the user; estimate, by the processor, an emotional state of the user based on at least one of voice information, image information, and operation information received through an input interface, and adjust at least one of content and a presentation method of the explanation information in accordance with the emotional state; store, in a storage device controlled by the processor, a history including anomaly detection results, cause specification results, countermeasure plans, and evaluation information received from the user, and update at least one of the anomaly detection, the cause specification, and the calculation of the countermeasure plan based on the history; generate, by the processor, a prompt sentence including summary information of the anomaly detection results, the cause specification results, and the countermeasure plans as input information, and transmit the prompt sentence from the server to an external generative artificial intelligence model to obtain, as a model output, a natural language explanation and an additional proposal; and integrate, by the processor, natural language output obtained from the generative artificial intelligence model into the explanation information, present the integrated explanation information to the user, and reflect feedback received from the user in at least one of generation of the prompt sentence and calculation of the countermeasure plan. This enables the server to implement a tightly integrated, processor-centric workflow that improves computer operation by efficiently coordinating time-series tracking, anomaly detection, cause analysis, simulation, optimization, and natural-language interaction, thereby reducing processing latency and redundancy, enhancing adaptability of internal models, and providing technically improved human-machine interfaces that leverage generative artificial intelligence within a closed computational feedback loop.

The term “processor” refers to a hardware computing unit or a collection of hardware computing units configured to execute machine-readable instructions, perform arithmetic and logical operations, control data flows between memories and interfaces, and carry out the functions described in the claims.

The term “user” refers to a human operator who interacts with the system through one or more input and output interfaces, provides input information and evaluation information, and receives explanation information and recommendations from the system.

The term “information input from a user” refers to data provided by the user through an input interface, including but not limited to textual input, selection of options on a graphical user interface, parameter settings, annotations, and evaluation feedback.

The term “visualize” refers to generating a graphical or otherwise perceptible representation of data, such as charts, graphs, dashboards, icons, or structured text layouts, that can be displayed to the user via a display device.

The term “graphical representation” refers to any visual arrangement of symbols, shapes, images, or text that depicts numerical or categorical data in a form interpretable by a human, including but not limited to line charts, bar charts, scatter plots, tables, and diagrams.

The term “temporal changes” refers to variations of values of data items over time, including sequences of measurements, trends, periodicities, and abrupt deviations observed in time-indexed data.

The term “time-series data” refers to data composed of values associated with respective time points or time intervals, where each data item includes at least one timestamp and one measured or derived value.

The term “time-series data store” refers to a logical or physical storage structure optimized for storing, indexing, and querying time-stamped data, and managed under control of the processor.

The term “measurement values” refers to numerical or categorical values obtained from one or more data sources, such as sensors, logs, or databases, which represent observed states, conditions, or events of a monitored system.

The term “data set including the temporal changes” refers to a collection of data elements that contain time-indexed values and any derived features based on those values, used as input for statistical processing and learning processing.

The term “statistical processing” refers to computational operations that analyze data using mathematical statistics, such as computing averages, variances, correlations, distributions, thresholds, or hypothesis tests.

The term “learning processing” refers to computational operations that adapt model parameters or structures based on data, including but not limited to machine learning and pattern recognition techniques used to improve performance in tasks such as classification, regression, or anomaly detection.

The term “anomaly” refers to a data pattern, data point, or sequence that deviates from an expected normal behavior according to a defined criterion or model, and is indicative of an abnormal or noteworthy condition.

The term “detect an anomaly” refers to computing and evaluating one or more measures of deviation from normal behavior and determining, based on such measures and one or more thresholds or decision rules, that an anomaly is present.

The term “context information” refers to additional data related to a detected anomaly, such as associated time intervals, locations, operating conditions, resource states, environmental conditions, and identifiers of entities involved.

The term “integrated information” refers to a combined data structure that results from aggregating, joining, or otherwise merging context information with other relevant data, enabling unified analysis by the processor.

The term “specify a cause of the anomaly” refers to identifying one or more factors, conditions, or events that have a significant influence on the occurrence or characteristics of the anomaly, based on analysis of integrated information.

The term “control variables” refers to parameters of a controlled process or system that can be adjusted by an operator or an automated controller, such as setpoints, rates, scheduling parameters, or resource allocations.

The term “operation conditions” refers to parameters describing the operational state of a system, including but not limited to load levels, shift patterns, process configurations, environmental conditions, and equipment statuses.

The term “changeable parameters” refers to values of control variables or operation conditions that are configured to be varied by the simulation process and/or optimization process to evaluate different scenarios or countermeasures.

The term “simulation process” refers to a computational procedure that models the behavior of a system or process under specified parameter values, and generates predicted outcomes based on that model.

The term “objective function” refers to a mathematically defined function of decision variables that represents a quantity to be optimized, such as cost, performance, quality, anomaly frequency, or resource utilization.

The term “constraint conditions” refers to mathematical expressions or logical rules that limit feasible values of decision variables in an optimization problem, including physical, safety, capacity, or policy constraints.

The term “optimization problem” refers to a mathematical formulation that includes an objective function, one or more decision variables, and one or more constraint conditions, and for which an algorithm seeks values of the decision variables that optimize the objective function while satisfying the constraint conditions.

The term “countermeasure plan” refers to a set of recommended changes to control variables, operation conditions, or other system parameters, derived from solving the optimization problem and intended to reduce anomalies or improve system performance.

The term “explanation information” refers to information generated by the processor that describes, interprets, or justifies at least one of anomaly detection results, cause specification results, or countermeasure plans in a form understandable by a user.

The term “human-interpretable form” refers to a representation of information, including natural language text, structured summaries, or annotated visualizations, that is comprehensible to a typical human user without requiring knowledge of internal data structures or model parameters.

The term “emotional state of the user” refers to an inferred affective condition of the user, such as stress, confusion, satisfaction, or urgency, estimated based on signals including voice patterns, facial expressions, posture, interaction speed, or input behavior.

The term “voice information” refers to audio data capturing vocal sounds produced by the user, including speech content and paralinguistic features such as pitch, volume, and tone.

The term “image information” refers to visual data capturing at least part of the user or the user's environment, including still images or video frames obtained from an imaging device.

The term “operation information” refers to data representing the user's interactions with an input device or interface, including keystrokes, pointing actions, touch gestures, navigation patterns, and timing information.

The term “presentation method” refers to a mode or style in which information is output to the user, including layout, level of detail, modality (such as visual, auditory, or haptic), emphasis, pacing, and interaction prompts.

The term “history” refers to stored records of past system operations, including anomaly detection results, cause specification results, countermeasure plans, explanation information, user interactions, and user evaluation information.

The term “evaluation information” refers to data that expresses a user's assessment of system outputs, such as ratings, comments, selections, confirmations, or corrections provided through the user interface.

The term “prompt sentence” refers to a textual input constructed by the processor that describes a task, context, or question for a generative artificial intelligence model, and that may include structured summary information as part of the input.

The term “summary information” refers to compacted representations of larger sets of data, including key statistics, selected features, labels, or conclusions extracted from anomaly detection, cause analysis, and optimization results.

The term “generative artificial intelligence model” refers to a computational model configured to generate natural language or other content based on an input prompt, typically implemented as a trained machine learning model such as a neural network.

The term “natural language explanation” refers to text generated in a human language that describes or interprets data, events, or model results in a way intended to be understandable by human users.

The term “additional proposal” refers to one or more suggestions, alternatives, or supplementary countermeasures generated by the generative artificial intelligence model, beyond the countermeasure plan computed directly by the optimization process.

The term “natural language output” refers to any textual sequence in a human language generated by the generative artificial intelligence model in response to a prompt sentence.

The term “integrate natural language output into the explanation information” refers to incorporating at least part of the natural language output into the explanation information, for example by merging, appending, or embedding the generated text within a report, summary, or user interface element.

The term “feedback received from the user” refers to any information provided by the user in response to system outputs, including acceptance, rejection, modification, ranking, or commentary on explanation information or proposed countermeasures.

The term “generation of the prompt sentence” refers to the process by which the processor constructs or updates the textual content, structure, and parameters of a prompt sentence to be input to the generative artificial intelligence model.

The term “calculation of the countermeasure plan” refers to the computational operations, including simulation and optimization procedures, by which the processor derives or updates a set of recommended actions or parameter changes to address detected anomalies.

In one embodiment, a server executes a program that implements the claimed system using a hardware configuration including at least one processor, a main memory, a non-volatile storage device, a network interface, and one or more input/output interfaces. The server is connected, via a communication network, to multiple terminals operated by users, and to external devices such as environmental sensors, production equipment controllers, and an external generative AI model service. The server stores executable instructions and configuration data in the non-volatile storage device and loads the instructions into the main memory for execution by the processor.

The server uses general-purpose computing hardware, such as a multi-core central processing unit and optionally a graphics processing unit, to perform numerical computations for statistical processing, machine learning, and simulation. The server runs a general-purpose operating system and application software including: a database management system for relational data, a time-series database for sensor data, a data analysis runtime such as a scripting language interpreter, a visualization engine, and a machine learning framework. In one concrete configuration, the server uses a relational database system functionally similar to a structured query language database, a time-series database functionally similar to a specialized time-series store, a scripting environment comparable to a high-level interpreted language with libraries analogous to data-frame analysis and numerical computation libraries, and a machine learning framework equivalent to a tensor-based computation library. The server may also use an optimization solver and a discrete-event simulation framework functionally similar to widely known numerical optimization and simulation libraries.

The server maintains, in the storage device, a data schema that separates and links several data structures: (i) raw sensor records represented as time-stamped tuples of measurements; (ii) derived feature vectors represented as multi-dimensional arrays keyed by time and entity identifiers; (iii) anomaly records represented as structures including anomaly scores, labels, and references to underlying time windows; (iv) cause analysis records represented as tabular associations of candidate factors with influence scores; (v) countermeasure plan records including decision variables and resulting performance estimates; (vi) user interaction logs including emotional state estimates and evaluation values; and (vii) prompt sentence records and generative AI outputs.

The server receives information from the user through the terminal. The terminal runs a browser or client application and sends input data such as configuration parameters, thresholds, and evaluation feedback to the server via a network protocol. The server stores such input in the relational database and uses it to configure program modules and update processing parameters. The user may input domain constraints, acceptable ranges for operating conditions, and preferences for how explanation information should be displayed. The terminal also transmits sensor selection and time range parameters when the user requests particular visualizations.

The server visualizes information by transforming data structures into graphical representations that are delivered to the terminal. The server invokes a visualization engine that maps columns of a data table or fields of a data structure to graphical elements such as axes, color encodings, and markers.

For example, the server may produce a line graph of temperature versus time, a bar chart of anomaly counts per device, or a scatter plot of two derived features. The server converts such representations into markup and script code consumable by the terminal's rendering engine. By performing this mapping on the server, the system reduces redundant computations on multiple terminals and keeps data transfers focused on compact visualization specifications, which improves communication efficiency.

The server records and tracks temporal changes by writing incoming sensor data into the time-series database and periodically aggregating the data into intermediate structures. Each incoming sensor message includes a device identifier, a timestamp, and a measurement vector such as temperature, humidity, vibration level, and power consumption. The server normalizes timestamps to a unified time base and stores measurements in a time-indexed table with partitioning by device or location.

The server further computes rolling statistics, such as moving averages and standard deviations, and stores them in additional columns or derived tables. This precomputation reduces processing time for later anomaly detection tasks, because the anomaly detection modules can directly access pre-aggregated features instead of recomputing them for each inference.

The server detects anomalies using a combination of statistical thresholds and machine-learning models. In one embodiment, the server uses an unsupervised anomaly detection algorithm based on an isolation-tree ensemble. The server constructs multiple random decision trees configured to isolate data points by recursively splitting feature space along random feature-value combinations.

The server executes training by feeding historical feature vectors into these trees. The server stores, for each tree, the structure of splits and the path length statistics. During inference, the server computes an anomaly score for each new feature vector as a function of the average path length across the ensemble. The server marks a data point as anomalous when the score exceeds a configurable threshold. In another embodiment, the server uses a neural autoencoder implemented as a multi-layer feedforward network with an encoder layer, one or more hidden layers, and a decoder layer. The server trains the autoencoder with historical “normal” data only, using a reconstruction loss function such as mean squared error. The server updates network weights by applying gradient descent or a variant such as Adam, computing gradients through backpropagation. During operation, the server calculates a reconstruction error for each input vector; when this error exceeds a learned or configured boundary, the server records an anomaly. By combining precomputed rolling statistics and autoencoder reconstruction errors, the server improves detection accuracy and reduces inference latency relative to simpler threshold-only approaches.

The server specifies causes of anomalies by analyzing contextual and historical data under program control. The server retrieves, from the relational database and time-series database, all records within a configurable time window around each anomaly event. These records include operating conditions such as machine speed settings, mode flags, environmental conditions such as room temperature and humidity, and resource-related attributes such as material batch identifiers and operator identifiers.

The server constructs a merged table keyed by time and entity identifiers. The server then computes correlation measures and trains auxiliary classification models that distinguish between anomalous and non-anomalous windows. For example, the server may train a decision tree classifier or a gradient-boosted tree ensemble using the contextual features as inputs and an anomaly label as an output. The server obtains feature importance scores from the trained model and stores them in the cause analysis records. The server ranks candidate factors based on these scores and additional statistics, such as how often each factor is present among anomalies relative to normal periods. This analysis provides a structured basis for specifying probable causes. Unlike manual assessment, the server evaluates high-dimensional feature combinations and complex interactions that are not apparent to human operators, and it uses machine-level consistency to avoid subjective bias.

The server calculates countermeasure plans by performing simulation and optimization on specific computational structures. For simulation, the server uses a discrete-event model where events represent operations such as job arrival, processing start, processing completion, maintenance start, and maintenance completion. The server stores events in an event queue ordered by simulation time.

The server advances the simulation by repetitively extracting the next event from the queue, executing event-handling routines that update system state variables such as queue lengths, machine states, and accumulated throughput, and scheduling future events. System state variables and event handling logic are maintained as data structures in memory. The server parameterizes processing times, failure rates, and quality probabilities as functions of control variables and operation conditions identified in the cause analysis. By running multiple simulation trials with different parameter combinations, the server computes performance metrics such as average throughput, variance of processing time, expected anomaly counts, and estimated defect rates.

For optimization, the server defines decision variables corresponding to control variables and operation conditions such as temperature setpoints, cycle times, maintenance intervals, or buffer sizes. The server formulates an objective function that combines predicted anomaly rates and performance metrics, for example as a weighted sum that penalizes high anomaly rates and throughput losses. The server encodes constraints including physical limits, safety bounds, and user-specified ranges. The server then executes an optimization algorithm such as linear programming, mixed-integer programming, or a meta-heuristic search. In the case of a linear or mixed-integer formulation, the server constructs coefficient matrices and passes them to an optimization solver; the solver iteratively updates candidate solutions and returns an optimal or near-optimal assignment for the decision variables. The server stores the resulting decision variable values and corresponding performance projections as countermeasure plans. By performing this combination of simulation and optimization under central processor control, the server significantly reduces the number of trial configurations required compared to manual exploration, thereby reducing computational load and network traffic to controlled devices.

The server generates explanation information by transforming internal numerical results and symbolic findings into structured, human-interpretable outputs. The server composes explanation segments that describe, for each anomaly, the factors that contributed most to its occurrence, the predicted effect of proposed countermeasures on anomaly frequency and system performance, and any trade-offs between different plans. The server uses templates stored in the database and fills them with variable content drawn from the cause analysis and optimization records. The server also attaches visual elements such as plots and tables by invoking the visualization engine to create minimal graphical specifications. The terminal receives this structured explanation information and renders it as interactive pages. The user can navigate through the pages, view drill-down details, and annotate or rate particular explanations.

The server estimates an emotional state of the user by processing input signals captured at the terminal or other sensors. The terminal may transmit audio streams, video frames, and user interaction logs such as cursor movements, keystroke dynamics, and response times. The server runs specialized analysis modules that transform these inputs into feature representations. For voice signals, the server extracts acoustic features such as pitch contours, energy profiles, and spectral coefficients. For video data, the server extracts facial landmarks, expression indices, and head pose features using a vision analysis library. For interaction data, the server computes metrics such as inter-click intervals, correction rates, and navigation patterns. The server feeds these features into a trained classification model, which may be a neural network or an ensemble model, to infer an emotional state category. The server then adjusts interface parameters accordingly. For example, when the server infers a high-stress state, it may simplify the information presented, increase font sizes, or provide additional explanatory text. This adjustment is implemented as a dynamic configuration of visualization templates and content selection logic, improving usability and enabling faster human understanding, which further reduces follow-up computational cycles prompted by user confusion.

The server cooperates with a generative AI model by constructing and transmitting structured prompt sentences, and by processing the returned natural language output as part of the system's internal workflow. The server maintains a prompt generation module that reads summary information from anomaly records, cause analysis results, and countermeasure plans. The module selects key fields, such as the type and frequency of anomalies, primary influencing factors with their importance scores, and the numerical impact of the best countermeasure plan. The server then assembles this information into a textual prompt sentence containing both context and explicit instructions. For example, the server may construct a prompt sentence such as:

“Analyze the following anomaly detection results and optimization-based countermeasure plan for a manufacturing line. Temperature spikes occur daily around 14:00 on Line A, with humidity above 80% and material lot X identified as key contributing factors. A countermeasure plan that reduces the oven temperature by 5 degrees and decreases line speed by 10% is predicted to reduce anomaly occurrence by 80% with a 5% throughput loss. Explain these findings in clear language for plant managers, suggest at least two alternative countermeasures that may further reduce anomalies with minimal throughput impact, and describe trade-offs for each option.”

The server sends this prompt sentence to an external generative AI model through a network interface using an application programming interface. The generative AI model is implemented on remote computing resources and returns a natural language output. The server receives the output, parses it if necessary to identify sections corresponding to explanations and additional proposals, and integrates it into the explanation information. The server also records user feedback on this AI-generated content, such as ratings or edits, and uses the feedback to update prompt generation rules and weightings for future prompts. By structuring the prompt based on internal model state and by reusing user feedback to refine prompt construction and local decision rules, the server uses the generative AI model as a compute-intensive natural language coprocessor in a closed loop, rather than as a simple text formatter. This configuration improves the quality and relevance of generated language while reducing unnecessary API calls and network overhead.

The server improves computer technology in multiple ways. By organizing data into explicitly defined time-series structures and derived feature stores, the server reduces repeated computation of common transformations and allows anomaly detection models to operate on pre-processed features with lower latency. By integrating simulation and optimization in a single orchestrated workflow under the processor's control, the server reduces the search space of candidate countermeasures and avoids redundant model evaluations, which leads to more efficient use of CPU and memory resources. By automatically adapting visualization content and presentation method based on estimated emotional state, the server decreases the number of user queries and clarifications, thereby reducing overall server load and network traffic. By constructing structured prompt sentences and integrating generative AI outputs in a feedback loop, the server limits the size and frequency of data transmitted to the external generative AI service while achieving improved explanation quality, leading to reduced communication overhead and more predictable execution times.

The server implements the described modules in a modular architecture. In one configuration, the server divides the program into a data ingestion module, a feature computation module, an anomaly detection module, a cause analysis module, a simulation module, an optimization module, an explanation generation module, an emotional state estimation module, and a generative AI interaction module. Each module communicates via well-defined data structures stored in the databases. The server schedules module execution using a task scheduler or message queue so that heavy computations such as model retraining and simulation batches run asynchronously or off-peak, minimizing interference with real-time anomaly detection. This modular architecture facilitates deployment on a distributed computing environment, such as multiple server nodes or a cloud platform, enabling the system to scale with increasing data volumes and complexity.

The terminal operates as a thin client that displays visualizations, explanation information, and AI-generated text, and collects user input and feedback. The terminal may be implemented as a handheld device, a desktop computer, or an industrial control panel equipped with a display, an audio interface, a camera, and input devices. The terminal sends captured input data to the server and renders responses without needing to execute heavy machine learning or optimization algorithms locally. This separation of roles allows the server to centralize intensive computing and to update models and algorithms without modifying terminal software.

The user interacts with the system through the terminal. The user may configure operating ranges, select objectives such as minimizing anomalies or balancing cost and throughput, and review proposed countermeasure plans. The user can provide ratings or comments on anomaly explanations and AI-generated suggestions, and the server uses these evaluations to refine models and prompts as described above. In one example, the user defines a generic system design prompt:

“Design a system that collects temperature and humidity data from a manufacturing production line, visualizes the data in real time, detects anomalies using machine-learning models, analyzes the root causes of detected anomalies, and proposes optimal countermeasures using simulation and optimization techniques.”

The server stores such a template and may later adapt it with specific data to generate concrete prompt sentences for the generative AI model. In another example, the user reviews a detailed report generated by the server and the generative AI model, identifies that one of the suggested countermeasures is impractical due to an external constraint, and records this feedback in the system.

The server then updates its constraint set and prompt generation rules to avoid similar impractical suggestions in future, thus implementing a form of human-in-the-loop model refinement that improves future computational efficiency and output quality.

Alternative embodiments may vary internal algorithms while maintaining the overall functional configuration. For anomaly detection, the server may employ recurrent neural networks or convolutional neural networks for time-series modeling instead of or in addition to isolation-tree ensembles and autoencoders. For cause analysis, the server may apply causal discovery algorithms or Bayesian networks. For optimization, the server may use heuristic search or reinforcement learning to tune control variables based on long-term performance outcomes. The server can incorporate data augmentation techniques, such as adding noise or synthetic anomalies to training data, to improve model robustness. In each case, the server defines explicit data structures, learning objectives, and update rules that are executed by the processor, and integrates them with the simulation, optimization, and generative AI interaction modules to deliver the technical effects described above.

Through these detailed configurations, the server, the terminal, and the user cooperate to realize a system that not only automates data handling, but also improves the internal operation of computer components themselves, including data organization, model execution, and human-machine interaction, thereby satisfying the requirements for a concrete technological implementation rather than an abstract idea.

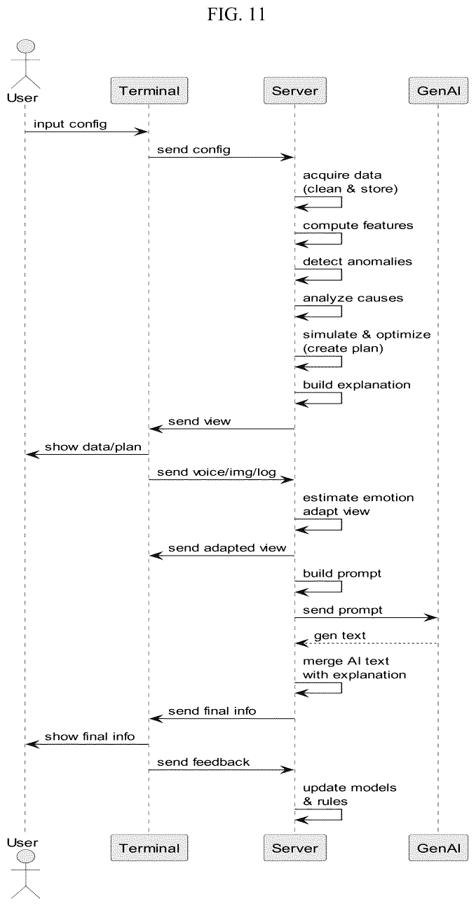

The following describes the processing flow using FIG. 11.

### Step 1

The server acquires raw data and user input parameters. The server receives, as input, time-stamped sensor measurements from external devices, log records from databases, and configuration parameters from the terminal specified by the user. The server parses incoming messages, validates record formats, and normalizes timestamps and identifiers. The server performs data processing that includes unit conversion, removal of invalid records, and mapping heterogeneous field names into a unified schema. The server outputs a cleaned and normalized data set stored in a time-series database and a relational database, with indices on time, device ID, and process ID.

### Step 2

The server computes derived features for time-series analysis. The server reads, as input, normalized raw measurements from the time-series database. The server performs data operations such as calculating moving averages, moving standard deviations, first-order differences, and time-of-day encodings for each measurement channel. The server groups records by device or production line and applies window functions over specified time spans. The server outputs a feature table in which each row corresponds to a time window and each column corresponds to a derived feature, storing this table in a feature store accessible to machine-learning modules.

### Step 3

The server visualizes current and historical data for the user. The server receives, as input, user-selected time ranges, device filters, and metric choices from the terminal. The server queries the time-series database and feature store to retrieve matching records, then aggregates the records into summary tables, for example computing per-minute or per-hour statistics. The server transforms these summary tables into visualization specifications that define chart types, axes, legends, and styles. The server outputs a structured description of dashboards, which the terminal renders as interactive charts and tables for the user to inspect.

### Step 4

The server detects anomalies in the time-series data. The server uses, as input, the feature table produced in Step 2 and model parameters previously stored in the storage device. The server applies preprocessing operations such as feature scaling and encoding to generate model-ready input tensors. The server executes an anomaly detection algorithm, for example evaluating an isolation-tree ensemble or computing reconstruction errors with a trained autoencoder network. The server compares each anomaly score against a decision threshold and labels each time window as normal or anomalous. The server outputs anomaly records that include time, device identifier, feature vector, anomaly score, and anomaly label, and stores these records in an anomaly log.

### Step 5

The server performs root-cause analysis for detected anomalies. The server takes, as input, anomaly records from the anomaly log and contextual data from the relational database, including operation settings, environmental conditions, and resource identifiers. The server joins these inputs into a combined context table keyed by time and device. The server executes statistical and learning computations, such as computing correlations, training a classifier that distinguishes anomalous windows from normal windows, and extracting feature importance scores from the classifier. The server ranks candidate causal factors based on importance scores and occurrence patterns. The server outputs cause analysis records that associate each anomaly cluster with one or more high-impact factors and their quantitative influence measures.

### Step 6

The server constructs and executes simulation scenarios. The server receives, as input, the cause analysis records, baseline operation parameters, and user-specified constraints from the terminal.

The server initializes a discrete-event simulation model by loading process definitions, resource capacities, and failure distributions into internal data structures. The server generates scenario configurations by varying control variables and operation conditions identified as influential in Step 5 within allowable ranges. For each scenario, the server runs the simulation, processing events in chronological order and updating system state variables such as queue lengths, machine states, and defect counts. The server records performance metrics for each scenario, such as throughput, average waiting time, and estimated anomaly frequency. The server outputs a scenario result table mapping each parameter configuration to corresponding performance metrics.

### Step 7

The server formulates and solves an optimization problem for countermeasure planning. The server takes, as input, the scenario result table from Step 6 and user preferences such as objective weights and acceptable performance thresholds. The server defines decision variables representing adjustable control variables and operation conditions, and constructs an objective function that combines predicted anomaly rates, defect costs, and throughput penalties. The server derives constraint inequalities from physical limits, safety bounds, and user-specified restrictions. The server encodes these elements into an optimization model and invokes an optimization solver to search for an optimal or near-optimal solution. The server outputs a countermeasure plan that specifies recommended values for decision variables and predicted performance indicators, and stores this plan in a countermeasure repository.

### Step 8

The server generates explanation information for anomalies, causes, and countermeasures. The server receives, as input, anomaly records from Step 4, cause analysis records from Step 5, and the countermeasure plan from Step 7. The server selects key elements such as anomaly frequency, top contributing factors, and expected improvement from the countermeasure plan. The server fills predefined explanation templates with these elements to produce structured text summaries and selects corresponding graphical views from the visualization engine. The server outputs explanation information that includes natural language descriptions, tables, and chart specifications, and transmits this information to the terminal for display to the user.

### Step 9

The server estimates the emotional state of the user and adapts presentation. The server uses, as input, voice data, image data, and interaction logs captured at the terminal during user sessions. The server extracts features such as acoustic parameters, facial expression indices, and interaction timing metrics. The server feeds these features into an emotion classification model and obtains an estimated emotional state label. Based on this label, the server adjusts presentation parameters such as level of detail, pacing of information, and visual emphasis by selecting among different explanation templates and visualization configurations. The server outputs adapted explanation content that is tailored to the user's inferred emotional state and sends it to the terminal.

### Step 10

The server constructs a prompt sentence for a generative AI model. The server takes, as input, summary information derived from anomaly logs, cause analysis results, and the countermeasure plan, along with prompt templates configured by the user. The server inserts key numerical and categorical values into placeholders in the template, such as the magnitude of anomaly reduction, main causal factors, and trade-off metrics. The server concatenates contextual description and explicit instructions to form a coherent prompt sentence. The server outputs a finalized prompt sentence in text format and stores it in a prompt log for traceability.

### Step 11

The server interacts with the generative AI model and integrates its output. The server uses, as input, the prompt sentence from Step 10 and communication parameters for accessing an external generative AI model service. The server sends the prompt sentence via a network interface to the generative AI model and receives natural language output in response. The server parses the output to identify explanation paragraphs and additional proposal sections and optionally filters or truncates content according to length and relevance constraints. The server merges selected portions of the natural language output into the explanation information generated in Step 8, for example by appending AI-generated explanations and listing AI-proposed alternative countermeasures. The server outputs an enriched explanation package that combines system-generated analytics and generative AI text, and transmits this to the terminal.

### Step 12

The terminal presents information and collects user feedback. The terminal receives, as input, visualization specifications, explanation information, and enriched natural language content from the server. The terminal renders charts, tables, and text on its display and may play audio explanations if provided. The user reviews anomaly details, cause factors, and countermeasure plans, and interacts with controls to approve, reject, or modify recommendations, and to rate the clarity and usefulness of explanations. The terminal captures these user actions as feedback events and sends them to the server. The terminal outputs structured feedback data, including ratings, comments, and decision flags, which the server uses for subsequent model updates and prompt refinement.

### Step 13

The server updates models and rules based on historical records and user feedback. The server takes, as input, stored histories of anomaly detection performance, cause analysis results, optimization outcomes, and feedback data received from the terminal. The server computes performance metrics such as detection accuracy, prediction error, and user satisfaction scores. The server retrains or fine-tunes anomaly detection models, cause analysis models, and emotional state classifiers using updated training sets that incorporate new data and labels. The server adjusts thresholds, feature selection rules, and prompt generation templates according to observed performance and user preferences. The server outputs updated model parameters, revised configuration values, and refined prompt templates, which are stored in the system for use in subsequent executions of Steps 1 through 12.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional factory monitoring and decision-support systems typically implement a simple pipeline in which sensor data are collected, displayed on dashboards, and optionally analyzed by separate analytics modules. In such systems, data acquisition, anomaly detection, cause analysis, and countermeasure planning are often implemented as loosely coupled software components, each operating on static or pre-aggregated datasets. As a result, these systems suffer from several technical limitations in terms of computer technology itself.

First, conventional architectures do not efficiently transform heterogeneous, high-frequency time-series data from multiple detection devices into unified feature representations that can be consumed in real time by anomaly detection models. Sensor data, user inputs, and historical logs are handled in different subsystems, often requiring manual or batch-oriented integration. This leads to increased processing latency, redundant data conversions, and high computational overhead when attempting to detect anomalies promptly, thereby degrading responsiveness of the overall system.

Second, conventional systems rarely support a closed-loop computational workflow that continuously reuses machine-learned models for both anomaly detection and countermeasure evaluation on a streaming basis. Typical implementations retrain models offline and apply them in a static manner, without sequentially updating determinations of abnormal states and evaluations of countermeasures as new time-series data arrive. This prevents the computing system from efficiently adapting model behavior to current operating conditions and limits the precision and timeliness of anomaly assessments and recommended actions.

Third, although natural-language interfaces and generative artificial intelligence models have emerged, conventional systems do not provide a structured mechanism for constructing rich context information that tightly integrates raw time-series data, detected abnormal states, ranked candidate causes, and machine-evaluated countermeasure plans into the prompts provided to such generative models. Without this integration, the computing system underutilizes internal analytical results and cannot consistently produce accurate, domain-specific natural-language recommendations. This leads to duplicated processing, increased user intervention to aggregate necessary information, and suboptimal utilization of computing resources.

Fourth, existing user interfaces typically treat all users uniformly and do not algorithmically adjust the presentation of recommended countermeasures based on an estimated emotional state of the user.

As a result, the system does not optimize interaction flows or information density according to the user's condition, which can increase the number of interactions, lengthen decision times, and place additional processing burdens on both the user terminal and backend server due to repeated clarification requests and queries.

Accordingly, there is a need for an improved computer-implemented system and server-side processing architecture that: (i) normalizes and stores heterogeneous operation information as unified time-series information, (ii) constructs and applies machine-learned models for anomaly detection and countermeasure evaluation in a continuous, streaming-oriented manner, (iii) automatically builds context information suitable for a generative artificial intelligence model from internal analytical results and user prompt sentences, and (iv) dynamically adjusts the presentation of recommended countermeasure plans based on estimated user emotional states. Such a system would improve the operation of computers themselves by reducing processing latency, lowering redundant computations, enhancing the quality and consistency of generated recommendations, and optimizing human-computer interaction flows.

The specific processing by the specific processing unit 290 of the data processing device 12 in Application Example 1 is realized by the following means.

The present invention provides a server comprising a processor configured to receive information input by a user, acquire operation information from detection devices and information storage devices installed in production equipment, normalize the acquired operation information and the information input by the user and store the normalized information as time-series information, generate feature quantities from the time-series information, and detect an abnormal operation state on the basis of the stored time-series information by performing statistical processing or machine learning processing using an anomaly detection model constructed from the feature quantities;

analyze a correlation or a causal relationship between time-series information in which the abnormal operation state is detected and other operation information and extract and rank candidate causes of the abnormal operation state; obtain countermeasure contents corresponding to the candidate causes from knowledge information, evaluate influences of a plurality of the countermeasure contents by simulation processing or optimization processing using an evaluation model constructed by a machine learning algorithm, and generate a recommended countermeasure plan; convert the acquired operation information, the detected abnormal operation state, the extracted candidate causes, and the generated recommended countermeasure plan into visual information and output the visual information to a display device; estimate an emotional state of the user from an input history or response content of the user and adjust content or format of presentation of the recommended countermeasure plan according to the emotional state; and receive, from the user, a prompt sentence described in natural language, generate context information including the prompt sentence, the operation information, the abnormal operation state, the candidate causes, and the recommended countermeasure plan, input the context information to a generative artificial intelligence model to cause the generative artificial intelligence model to generate a natural-language explanation and an additional countermeasure proposal, and present a result of the natural-language explanation and the additional countermeasure proposal to the user. This enables the computer system to implement an integrated, low-latency processing pipeline that continuously transforms heterogeneous sensor and user data into unified time-series features, applies machine-learned models for real-time anomaly detection and countermeasure evaluation, automatically constructs rich context for a generative artificial intelligence model, and dynamically optimizes user interaction based on estimated emotional state, thereby improving the efficiency, responsiveness, and technical performance of the underlying computer architecture.

The term “processor” refers to a hardware processing unit, such as a central processing unit or a combination of processing units, that executes machine-readable instructions to perform the functions described in the present specification.

The term “user” refers to a human operator who interacts with the system by providing input information, prompt sentences, or responses and by viewing or utilizing outputs generated by the system.

The term “information input by a user” refers to data explicitly provided by the user through an input interface, including textual input, selection operations, confirmation operations, or other interaction operations.

The term “operation information” refers to data representing an operational state of equipment, processes, or systems, and includes measurement values, status signals, event logs, and control parameters obtained from detection devices or information storage devices.

The term “detection device” refers to a sensing apparatus or monitoring apparatus that measures physical or logical quantities of equipment or processes, such as temperature, vibration, pressure, current, state, or event occurrence.

The term “information storage device” refers to a storage apparatus or storage system that stores operation information, including databases, file systems, and memory devices.

The term “normalize” refers to processing that converts heterogeneous data formats, units, scales, or structures of information into a unified representation according to predefined rules, enabling consistent storage and analysis.

The term “time-series information” refers to data that are associated with time indices and represent changes of one or more variables over time, including raw time-stamped measurements and derived features computed over temporal windows.

The term “statistical processing” refers to computation that applies statistical techniques, such as averaging, variance calculation, correlation calculation, threshold comparison, and hypothesis testing, to analyze data.

The term “machine learning processing” refers to computation that uses one or more machine learning algorithms to train, update, or apply predictive or descriptive models based on data.

The term “abnormal operation state” refers to an operational condition of equipment or processes that deviates from a normal or expected pattern beyond a predetermined criterion, as determined by statistical processing or machine learning processing.

The term “correlation” refers to a statistical relationship between variations of two or more variables, quantified by a correlation coefficient or similar metric.

The term “causal relationship” refers to a relationship in which a change in one variable is inferred to influence a change in another variable, as determined by causal inference techniques or domain rules.

The term “candidate cause” refers to a factor or condition that is identified as a possible source or contributor to an abnormal operation state and is associated with a likelihood or ranking.

The term “knowledge information” refers to structured or unstructured information that describes known relationships among operation information, abnormal cases, causes, and countermeasure contents, including rule sets, case histories, and domain expertise data.

The term “countermeasure contents” refers to one or more actions or configurations intended to mitigate, correct, or prevent an abnormal operation state or its causes.

The term “simulation processing” refers to computation that virtually executes a model of equipment or processes under assumed conditions in order to estimate effects of countermeasure contents on performance indicators.

The term “optimization processing” refers to computation that formulates and solves an optimization problem to select or adjust countermeasure contents so as to satisfy constraints and optimize one or more objective functions.

The term “recommended countermeasure plan” refers to a set of one or more countermeasure contents, including associated parameters and execution conditions, that is selected or generated by the system as preferable according to evaluation results.

The term “visual information” refers to information formatted for display on a human-perceivable display device, including graphs, charts, tables, icons, textual summaries, or combined representations.

The term “display device” refers to a hardware component capable of presenting visual information to the user, such as a monitor, a panel display, or a mobile device screen.

The term “emotional state of the user” refers to an internal state of the user, such as stress level, confidence level, or attentiveness, inferred from the user's input history, response content, or interaction patterns.

The term “prompt sentence” refers to a natural-language expression input by the user to request analysis, explanation, or recommendation from the system, particularly from a generative artificial intelligence model.

The term “context information” refers to a structured or semi-structured set of information including at least a prompt sentence, operation information, abnormal operation states, candidate causes, and a recommended countermeasure plan, which is provided as input to a generative artificial intelligence model.

The term “generative artificial intelligence model” refers to an artificial intelligence model that generates natural-language text or other output content based on input context information, including large language models and similar generative models.

The term “natural-language explanation” refers to text generated in a human language that describes analysis results, causes, or system states in a form understandable by the user.

The term “additional countermeasure proposal” refers to one or more countermeasure contents or plans generated by the generative artificial intelligence model in addition to or as an alternative to the recommended countermeasure plan.

The term “learning data” refers to data used to train, fine-tune, or adapt the generative artificial intelligence model or other machine learning models, including operation information, abnormal cases, causes, and countermeasure plans.

The term “model setting information” refers to configuration parameters of a model, including but not limited to weights, hyperparameters, prompt templates, or system instructions, that influence operation of the model.

The term “feature quantities” refers to numerical or categorical values derived from raw time-series information, representing characteristics of the data in forms suitable as inputs to machine learning models.

The term “anomaly detection model” refers to a machine-learned model configured to determine whether a given input, such as a feature quantity vector, corresponds to a normal state or an abnormal operation state.

The term “evaluation model” refers to a machine-learned model configured to estimate or score effects or performance of countermeasure contents with respect to one or more evaluation criteria.

In one or more embodiments, the system includes a server, at least one terminal, and various detection devices and information storage devices installed in production equipment of a plant. The server executes a program stored in a non-transitory computer-readable medium. The program causes the server to perform operations corresponding to the functions recited in the claims.

The server includes at least one processor, a main memory, a storage device such as a magnetic disk or solid-state drive, and a network interface. The terminal includes a processor, a display device, an input device, and a network interface. Detection devices include, for example, temperature sensors, vibration sensors, pressure sensors, flow sensors, and controllers. Information storage devices include, for example, relational databases and time-series databases implemented on storage subsystems.

In a typical embodiment, the server operates in a client-server architecture. The terminal communicates with the server via a communication network using a communication protocol such as HTTPS or WebSocket. The terminal displays visual information provided by the server and transmits user input information and prompt sentences described in natural language to the server.

The server stores an application program that implements data acquisition, normalization, time-series storage, anomaly detection, cause analysis, countermeasure evaluation, emotional state estimation, and generative AI-based recommendation. The server uses an operating system such as a general-purpose server operating system, a web server such as a general-purpose HTTP server, and an application framework such as a general-purpose web framework. The server also uses a relational database management system such as a general-purpose SQL database and a time-series database such as a general-purpose time-series data store. For machine learning processing, the server uses a numerical computation library, a machine learning library, and a deep learning framework.

The server acquires operation information from detection devices and information storage devices installed in production equipment. The server receives sensor measurements such as temperature, vibration acceleration, pressure, electric current, and rotational speed as time-stamped records via a messaging protocol such as MQTT or via HTTP requests. The server also acquires historical operation logs, maintenance records, and configuration parameters from the information storage devices.

The server normalizes heterogeneous operation information and user input information. The server converts different units into common units, aligns timestamps into a common time base, encodes categorical states into numerical representations, and maps free-form textual fields into structured codes using predefined dictionaries. The server stores normalized data in a time-series structure. In one embodiment, the server uses a time-series schema having fields such as a device identifier, a variable identifier, a timestamp, and a value. The server uses an index on the device identifier and the timestamp to enable fast retrieval of contiguous time windows.

The server generates feature quantities from the time-series information. The server calculates statistical features such as moving averages, moving standard deviations, maximum values, minimum values, peak-to-peak values, and gradients over sliding windows. The server also computes frequency-domain features from vibration signals using discrete Fourier transform or fast Fourier transform. The server forms feature vectors that include, for example, a temperature mean, a temperature gradient, a vibration root-mean-square value, and a spectral peak around a specific frequency band. The server stores the feature vectors in a dedicated feature table, indexed by timestamp and device identifier.

The server constructs an anomaly detection model from feature quantities using a machine learning algorithm. In one embodiment, the server uses an unsupervised anomaly detection algorithm such as an isolation-based algorithm implemented in a machine learning library. The server trains the anomaly detection model on feature vectors that represent normal operation periods. The server sets parameters such as the number of estimators, the subsampling size, and the contamination ratio. The server constructs a forest of decision trees that partition the feature space. The server uses path lengths in the trees to compute anomaly scores. Because the feature vectors are normalized and indexed, the server can efficiently compute scores for new data, thereby improving processing speed and reducing memory consumption.

In another embodiment, the server uses a neural network-based anomaly detection model, such as an autoencoder. The server configures the autoencoder with an input layer corresponding to the dimension of the feature vectors, one or more hidden layers, and a bottleneck layer having a lower dimension. The server trains the autoencoder by minimizing a reconstruction error, such as mean squared error, between input feature vectors and reconstructed feature vectors. The server updates model parameters using stochastic gradient descent or a variant thereof, with a learning rate, batch size, and regularization parameter. After training, the server uses the reconstruction error as an anomaly score. Because the autoencoder captures non-linear relationships among features, the server can detect complex abnormal operation states that are difficult for rule-based systems to capture.

The server detects an abnormal operation state by comparing anomaly scores to a threshold. The server determines the threshold based on a distribution of scores in training data or based on a percentile criterion. The server flags a feature vector as abnormal if its score is beyond the threshold.

The server then associates the abnormal feature vector with underlying raw time-series measurements and device identifiers. As a result, the server can rapidly identify abnormal segments in continuous streams without scanning the entire data set repeatedly, which reduces computational load and detection latency.

The server analyzes correlation and causal relationships between time-series information in which an abnormal operation state is detected and other operation information. The server computes correlation coefficients between the target variable and candidate explanatory variables over a time window that includes the abnormal period. The server also constructs a causal graph representing dependencies among variables. In one embodiment, the server uses a graphical model library to construct a directed graph whose nodes correspond to variables such as temperatures, flows, speeds, and vibration levels. The server estimates edges and directions using structure learning or predefined domain rules. The server then performs interventions in the model, such as fixing a variable to a normal value and measuring the effect on the predicted probability of an abnormal state. In this manner, the server identifies candidate causes that have a strong causal effect on abnormal states.

The server extracts and ranks candidate causes according to scores derived from correlation, causal influence, and occurrence frequency. The server stores the candidate causes with scores and links them to specific abnormal events. The server thereby provides a structured machine-interpretable representation of causes that is re-usable by subsequent processing modules.

The server obtains countermeasure contents corresponding to the candidate causes from knowledge information. The server maintains a knowledge base that associates cause identifiers with typical countermeasure patterns, such as reducing a speed, inspecting a component, recalibrating a sensor, or adjusting a process parameter. The server retrieves multiple alternative countermeasure contents for each cause. The server then evaluates influences of these countermeasure contents by simulation processing or optimization processing.

In one embodiment, the server simulates process behavior under different countermeasure scenarios using a discrete-event simulation library. The server models each piece of production equipment as an entity with state variables such as operational status, throughput, and failure probability. The server defines events such as maintenance actions, parameter changes, and failures. For each candidate plan, the server executes the simulation over a horizon, collects metrics such as total throughput, downtime, and defect counts, and computes cost metrics. Because the simulation is executed in software with efficient event scheduling and sparse state updates, the server can evaluate numerous scenarios faster than real time.

In another embodiment, the server formulates an optimization problem where decision variables represent, for example, maintenance timing, allocation of loads among parallel lines, and extent of parameter changes. The server defines objective functions such as minimizing downtime and cost while satisfying constraints on product quality and safety. The server uses an optimization solver to compute near-optimal values of decision variables. As a result, the server selects a recommended countermeasure plan that is globally better than naive or local-only plans.

The server converts the acquired operation information, the detected abnormal operation state, the extracted candidate causes, and the generated recommended countermeasure plan into visual information. The server aggregates time-series data into display-friendly formats such as line plots, bar charts, and state timelines. The server encodes abnormal segments using color coding and overlays annotations indicating candidate causes and recommended actions. The server transmits the visual information to the terminal. The terminal displays the visual information on a display device as dashboards, reports, or interactive charts. Because the server pre-aggregates and compresses data into efficient visual structures, the amount of data transmitted over the network is reduced, which lowers communication load and improves responsiveness at the terminal.

The server receives information input by a user through the terminal. The user can input manual labels indicating whether a suggested cause is correct, whether a recommended action was executed, and whether the result was satisfactory. The server uses this feedback to update model parameters or rule weights. The user can also input configuration preferences, such as sensitivity levels and display options.

The server estimates an emotional state of the user from input history and response content. The server analyzes temporal patterns of interactions, such as input frequency, response delays, and correction operations. The server also analyzes linguistic content of user messages using a text analysis module based on a neural network trained on sentiment or emotion labels. The server generates an emotional state vector representing dimensions such as stress, urgency, and confidence.

The server then adjusts the content or format of presentation according to the emotional state. For example, when the server detects a high stress level, the server may simplify technical details, present concise recommendations, and highlight high-priority actions. When the server detects a low stress and high familiarity state, the server may include more detailed analysis and options. This dynamic adaptation reduces cognitive load, decreases the number of clarification queries, and improves the overall interaction efficiency.

The server receives a prompt sentence described in natural language from the user. The terminal sends the prompt sentence, such as:

“Based on the latest sensor data and detected anomalies on Line 3, explain the most likely causes and propose specific countermeasures with estimated effects on throughput and quality.”

or

“Using the current vibration and temperature data from Motor M-203 and Furnace F-1, summarize all critical anomalies, identify the most probable root causes, and propose an action plan that balances production continuity and equipment safety.”

to the server via the network. The server generates context information including the prompt sentence, relevant operation information, abnormal operation states, candidate causes, and the recommended countermeasure plan. The server structures the context using, for example, sections for system instructions, summarized numerical data, and user question text.

The server provides the context information to a generative AI model. In one embodiment, the server accesses a large language model hosted on a remote computation resource via an API. In another embodiment, the server hosts a local generative AI model implemented using a deep learning framework. The model may be a transformer-based neural network with multiple layers of self-attention and feedforward blocks, trained on large corpora of text and fine-tuned on domain-specific data. The server configures model parameters such as decoding temperature, maximum output length, and system instruction text to tailor responses.

The server uses learning data including operation information, abnormal cases, causes, and countermeasure plans to fine-tune or adapt the generative AI model. The server updates model setting information, including prompt templates and internal weights, using techniques such as supervised fine-tuning or reinforcement learning from feedback. The server employs a loss function, such as cross-entropy loss between generated tokens and reference tokens, and updates weights using gradient-based optimization. Through this adaptation, the generative AI model learns to reference internal analytical outputs in a structured manner and to generate domain-appropriate natural-language explanations and additional countermeasure proposals.

The generative AI model generates a natural-language explanation and an additional countermeasure proposal based on the context information. The server receives the generated text, optionally segments it into sections such as summary, detailed analysis, and recommended actions, and filters or annotates content that violates constraints. The server presents the result to the user via the terminal. Because the server pre-structures the context with machine-generated analytical outputs and domain-specific knowledge, the generative AI model operates more efficiently and produces more accurate and consistent explanations than when directly applied to raw text. This improves both calculation efficiency and output quality of the natural-language processing pipeline.

In this system, the server does not merely automate human reasoning. Instead, the server implements non-conventional data structures and algorithmic flows specifically tailored to high-frequency time-series analysis and integrated decision support. The server constructs feature vectors in indexed time-series tables, applies machine-learned models incrementally as new data arrive, and reuses intermediate representations for both anomaly detection and countermeasure evaluation. The server also integrates these analytical artifacts into prompt sentences for the generative AI model, which a human user would not be able to construct consistently at the same speed.

Consequently, the system improves computer technology in several ways. First, the use of normalized time-series schemas with indexed feature tables reduces computational complexity of anomaly detection, enabling lower latency for streaming analysis. Second, the reuse of shared feature quantities and models for both detection and evaluation reduces duplicated computation and improves overall calculation efficiency. Third, the structured integration of analytical outputs into context information for the generative AI model reduces the need for ad-hoc, unstructured text processing and decreases token usage and transmission size, thereby lowering communication load to an external model service. Fourth, the dynamic adaptation of output presentation based on estimated emotional state reduces unnecessary interactions and repeated queries, which in turn reduces processing cycles in both the server and the terminal.

The server can be implemented in various alternative embodiments. For example, the anomaly detection model may be realized as a one-class support vector machine, a clustering-based model, or a recurrent neural network instead of an isolation-based model or an autoencoder. The generative AI model may be a sequence-to-sequence network, a mixture-of-experts architecture, or another transformer-type model. The causal analysis may use different structure learning algorithms, such as score-based search or constraint-based search. The simulation module may be replaced or supplemented by a model predictive control module. The emotional state estimation can employ different neural architectures, such as a convolutional network for key-stroke patterns or a recurrent network for dialogue history. These variations can be combined according to system requirements without departing from the technical scope defined by the claims.

The terminal can be realized as a stationary computing device, a portable computing device, or a dedicated control panel. The terminal may run a web browser that accesses a web application served by the server, or a native application that communicates with the server using an application programming interface. The user can input prompt sentences through a keyboard, a touch panel, or speech recognition, and can view visual information and generative outputs on the display device.

Through these concrete structures and operations, the server, terminal, and associated models collectively provide a technically improved system that transforms raw sensor signals into actionable, optimized recommendations with reduced latency, improved anomaly detection accuracy, enhanced data management, and lower communication overhead.

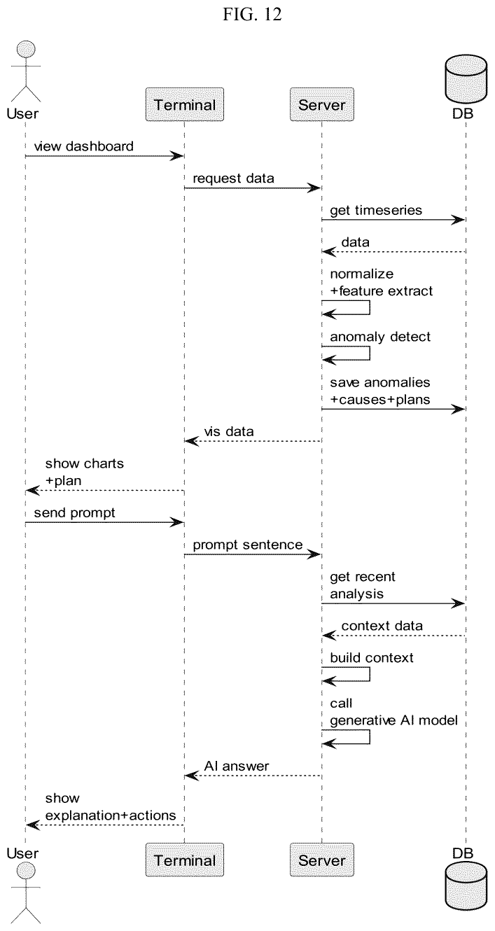

The following describes the processing flow using FIG. 12.

### Step 1

The server acquires raw operation information from detection devices and information storage devices.

The input is streaming measurement data (for example, temperature, vibration, pressure) including device identifiers and timestamps, and stored historical logs retrieved from databases. The output is a unified raw data buffer on the server. The server receives sensor messages via a communication protocol such as MQTT or HTTPS, parses payloads into internal records, and appends them to an in-memory queue and to a raw data table in a database.

### Step 2

The server normalizes the acquired raw data and user input information.

The input is the raw data buffer from Step 1 and user input records (for example, equipment selection, manual notes) received from the terminal. The output is normalized records having a standard schema, units, and timestamp format. The server converts measurement units to standard units, aligns timestamps to a common time base, maps device identifiers to canonical identifiers, and encodes categorical fields into numerical codes, then stores the normalized records in a time-series table.

### Step 3

The server generates time-series feature quantities from the normalized records.

The input is the normalized time-series data from Step 2. The output is a feature table containing feature vectors indexed by device and time. The server groups records into sliding time windows, computes statistics such as moving average, moving standard deviation, maximum and minimum values, gradients, and frequency-domain features, and writes each set of computed values as a feature vector into a dedicated feature database.

### Step 4

The server applies an anomaly detection model to the feature quantities to detect abnormal operation states.

The input is the feature table produced in Step 3. The output is a list of anomaly records including timestamps, device identifiers, feature vectors, and anomaly scores. The server loads a pre-trained anomaly detection model, such as an isolation-based model or an autoencoder, computes anomaly scores for each feature vector, compares the scores to a threshold, and generates anomaly records for feature vectors that exceed the threshold.

### Step 5

The server analyzes correlations and causal relationships around detected anomalies to extract candidate causes.

The input is the list of anomaly records from Step 4 and the corresponding time-series data in a neighborhood around each anomaly. The output is a set of candidate cause records with associated scores and rankings. The server retrieves time windows around each anomaly, computes correlation coefficients between the anomalous variable and other variables, evaluates causal influence using a causal graph or domain rules, calculates scores based on correlation and causal strength, and registers high-scoring variables as candidate causes.

### Step 6

The server retrieves countermeasure contents corresponding to candidate causes from a knowledge base.

The input is the candidate cause set from Step 5 and stored knowledge information defining mappings from causes to countermeasures. The output is a list of countermeasure options grouped by cause. The server looks up each candidate cause identifier in the knowledge base, obtains associated countermeasure templates (for example, parameter adjustments, maintenance actions), resolves any required parameters, and constructs structured countermeasure records.

### Step 7

The server evaluates countermeasure options by simulation or optimization to generate a recommended countermeasure plan.

The input is the countermeasure list from Step 6 and models of the production process stored in the server. The output is a recommended countermeasure plan with selected actions and predicted impact metrics. The server simulates the process under different countermeasure scenarios or formulates and solves an optimization problem, computes evaluation metrics such as expected downtime, throughput, and cost, compares the metrics across scenarios, and selects a set of actions with the best overall performance as the recommended plan.

### Step 8

The server converts internal analytical results into visual information and sends them to the terminal.

The input is the normalized time-series data, anomaly records, candidate causes, and the recommended countermeasure plan from Steps 2, 4, 5, and 7. The output is display-ready visualization data such as chart configurations and annotated timelines. The server aggregates time-series values into plotting series, marks anomaly intervals, attaches labels for causes and actions, formats the data into a visualization structure, and transmits the visualization data to the terminal over the network.

### Step 9

The terminal renders and displays the visualization to the user.

The input is the visualization data provided by the server in Step 8. The output is a graphical user interface presenting charts, tables, and annotations on the display device. The terminal interprets the visualization structure, draws time-series graphs, highlights abnormal segments, shows lists of candidate causes and the recommended countermeasure plan, and updates the screen when new data are received.

### Step 10

The user reviews the displayed information and provides feedback or configuration input.

The input is the visual information shown on the terminal screen and the user's observations. The output is user input events sent back to the server, such as confirmations, corrections, or preference updates. The user selects equipment, acknowledges recommended actions, optionally edits parameters, and adds comments through input devices; the terminal packages these interactions into structured messages and transmits them to the server.

### Step 11

The server estimates the emotional state of the user from interaction history and response content.

The input is the user interaction log from Step 10, including timestamps, frequencies of operations, and textual comments. The output is an emotional state vector or label representing, for example, stress or urgency. The server computes derived metrics such as input rate and correction frequency, applies a text analysis model to user comments, combines these indicators into features, and feeds them into an emotional state classifier that outputs an estimated emotional state for the current session.

### Step 12

The server adjusts the content and format of the recommended countermeasure plan according to the estimated emotional state.

The input is the recommended countermeasure plan from Step 7 and the emotional state estimate from Step 11. The output is an adapted presentation profile and modified explanation text or layout parameters. The server selects a presentation style (for example, concise summary or detailed breakdown), adjusts the level of technical detail, reorders items by priority, and sets display flags that instruct the terminal how to emphasize or simplify certain information.

### Step 13

The user inputs a prompt sentence in natural language to request analysis or recommendations.

The input is the user's intention, based on the situation observed on the terminal display. The output is a prompt sentence entered via the terminal and transmitted to the server. The user types or speaks a request such as “Based on the latest sensor data and detected anomalies on Line 3, explain the most likely causes and propose specific countermeasures with estimated effects on throughput and quality.” or “Using the current vibration and temperature data from Motor M-203 and Furnace F-1, summarize all critical anomalies, identify the most probable root causes, and propose an action plan that balances production continuity and equipment safety.”, and the terminal sends the textual prompt to the server.

### Step 14

The server assembles context information for a generative AI model using the prompt sentence and internal data.

The input is the prompt sentence from Step 13 and the internal analytical data from Steps 2, 4, 5, and 7. The output is a structured context representation containing system instructions, summarized numerical data, analytical findings, and the user's prompt. The server retrieves recent anomalies, candidate causes, and the recommended countermeasure plan for the relevant equipment, compresses time-series trends into key statistics, embeds these elements into a context template together with the prompt sentence, and prepares the context for submission to the generative AI model.

### Step 15

The server provides the context information to the generative AI model to obtain a natural-language explanation and additional countermeasure proposal.

The input is the context representation from Step 14. The output is a generated text response comprising explanations, justifications, and additional or alternative countermeasure suggestions.

The server sends the context to a generative AI model via an interface, receives the generated text, and optionally segments the text into sections such as overview, cause explanation, and recommended actions based on markers or headings in the output.

### Step 16

The server delivers the generated explanation and additional countermeasure proposal to the terminal for presentation to the user.

The input is the generated text from Step 15 and the adapted presentation profile from Step 12. The output is a formatted response object sent to the terminal. The server applies the chosen presentation style, such as selecting which sections to highlight, adding bullet points, or attaching links to detailed charts, encapsulates the formatted content, and transmits it to the terminal.

### Step 17

The terminal displays the generative AI model's response and enables the user to act on the recommendations.

The input is the formatted response object from Step 16. The output is a user interface view showing the natural-language explanation and additional countermeasure proposal integrated with existing dashboards. The terminal renders the text alongside relevant charts, provides controls for the user to accept or reject actions, and records any follow-up inputs; the user can then use these recommendations to adjust equipment settings or schedule maintenance.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional business management systems that perform data collection, visualization, tracking, anomaly detection, and countermeasure planning typically separate numerical analysis functions from natural-language explanation and recommendation functions. In such systems, a server-side analytical engine may generate predictions and anomaly scores, but the generation of human-readable analyses and actionable countermeasures often relies on manual work by users or on fixed-rule templates. This separation causes several technical problems in a computer system. First, conventional architectures do not tightly integrate structured analytical outputs with generative artificial intelligence models through prompt sentences. Analytical results, such as prediction values and anomaly indicators, are often only stored in databases or displayed in static dashboards. As a result, a generative AI model, if used at all, receives only a free-form natural-language prompt from the user without machine-readable, context-rich analytical data. This leads to suboptimal utilization of the model's computational resources, lower accuracy of generated explanations, and difficulty in consistently reflecting the most recent analytical state of the system.

Second, conventional systems do not provide an automated mechanism in which the processor systematically combines user-provided prompt sentences with structured prediction and anomaly detection results, supplies the combined input to a generative AI model, and then tightly couples the generated natural-language output back to visualization data such as graphs and charts. Because of this lack of end-to-end integration, the user must manually cross-reference generated text with separate charts and tables, which increases cognitive load, introduces latency in decision making, and reduces the overall throughput of the computer system in supporting complex business analysis tasks.

Third, typical systems do not leverage feedback from the history of prompt sentences, generated responses, and their evaluation results to iteratively improve both the analytical engine and the generative AI model. Without treating such interaction history as machine-learning training data, the processor cannot adapt model behavior to domain-specific patterns, and cannot computationally optimize the generation of countermeasures based on their past effectiveness. This results in a static system that fails to improve its internal models and algorithms as more data and user interactions accumulate.

Fourth, existing systems generally do not adapt system outputs in real time based on an estimated emotional state of the user as inferred from interaction patterns at the terminal. User interfaces often present the same complexity of information regardless of user stress, confusion, or engagement levels. This can lead to inefficient use of processing and rendering resources and may cause the user to issue more queries or corrections, increasing server load and network traffic.

Accordingly, there is a need for a computer-implemented system and processing method in which a processor (i) stores and preprocesses data for machine learning, (ii) executes prediction and anomaly detection by an artificial intelligence engine, (iii) automatically structures and binds analytical outputs with user-specified prompt sentences, (iv) invokes a generative AI model to produce natural-language analyses and countermeasures that are computationally grounded in current analytical data, (v) iteratively refines models using historical prompt-response pairs and evaluation results, and (vi) controls presentation content based on an estimated emotional state of the user. Such a system would improve the technical functioning of the computer in executing complex, data-driven analysis and communication tasks with reduced manual intervention, improved responsiveness, and higher quality of generated outputs.

The specific processing by the specific processing unit 290 of the data processing device 12 in Example 2 is realized by the following means.

The present invention provides a server comprising a processor and a storage device, the processor being configured to receive, via a terminal, information input by a user; store the information in the storage device; perform preprocessing on the stored information including at least missing-value processing, normalization processing, and outlier processing; execute, by using an artificial intelligence engine that runs a machine learning algorithm, prediction processing and anomaly detection processing on the preprocessed information; aggregate prediction results and anomaly detection results obtained by the artificial intelligence engine and structure them as summary information and statistical information; receive, via the terminal, a prompt sentence input by the user in natural language; generate input data by combining the prompt sentence with the structured summary information and statistical information; provide the input data to a generative AI model; cause the generative AI model to generate, on the basis of the input data, an analysis result in natural language including at least causes of anomalies and candidate countermeasures; associate the generated analysis result with the prediction results and the anomaly detection results and format them as report information to generate display data including a visual representation; transmit the display data to the terminal so that the display data is presented on the terminal in a form including at least one of a graph and a chart; estimate an emotional state of the user on the basis of information input by the user and behavior information acquired from the terminal; and control, in accordance with the emotional state, at least one of content of the prompt sentence to be suggested to the user and content of presentation of the analysis result, and further being configured, in some embodiments, to sequentially supply, as learning data, the prediction results, the anomaly detection results, and a correspondence between past prompt sentences and generated responses to the generative AI model so as to adapt the generative AI model to domain-specific knowledge, experience, and skills, and to apply a machine learning algorithm using historical data and evaluation results of past candidate countermeasures to calculate an evaluation index regarding effectiveness of candidate countermeasures. This enables the computer system to automatically and efficiently transform raw business data into preprocessed machine-learning-ready data, to perform prediction and anomaly detection with improved consistency, to tightly integrate structured analytical outputs with user prompt sentences for context-aware generative processing, to generate and refine natural-language analyses and countermeasures that are computationally grounded in current data and historical performance, to present synchronized textual and graphical results adapted to the user's emotional state, and to enhance the overall technical performance of the server in executing complex analytical and explanatory tasks with reduced manual intervention and improved accuracy and responsiveness.

The term “terminal” refers to an information processing apparatus, such as a client computer, a mobile device, or any user interface device, that communicates with a server over a communication network and allows a user to input information and view output data.

The term “user” refers to a human operator who interacts with the system via the terminal by inputting information, issuing instructions, and reviewing results provided by the system.

The term “server” refers to an information processing apparatus, including at least one processor and a storage device, that executes programs to receive, store, preprocess, analyze, and output data in response to inputs from the terminal.

The term “processor” refers to one or more hardware processing units, such as a central processing unit or graphics processing unit, and associated control circuitry, that execute instructions to perform the functions described for the system.

The term “storage device” refers to any non-transitory computer-readable medium, such as a magnetic storage device, a solid-state storage device, or a storage subsystem, configured to store data and programs used by the processor.

The term “information input by a user” refers to data provided by the user through the terminal, including but not limited to business-related numerical data, categorical data, configuration parameters, and natural-language text.

The term “preprocessing” refers to a series of data transformation and cleaning operations applied to raw stored information to prepare it for analysis, including but not limited to missing-value processing, normalization processing, and outlier processing.

The term “missing-value processing” refers to a data processing operation in which records that lack values for one or more fields are handled by operations such as imputation, deletion, or interpolation so that the data set becomes suitable for subsequent analysis.

The term “normalization processing” refers to a data transformation operation in which numerical values are rescaled or standardized according to a predetermined rule so as to reduce scale-dependent effects when applying machine learning algorithms.

The term “outlier processing” refers to a data processing operation in which values that deviate significantly from typical patterns in the data are detected and handled, including marking, removal, or modification, according to predetermined criteria.

The term “artificial intelligence engine” refers to a software component executed by the processor that implements one or more machine learning algorithms to perform tasks such as prediction processing and anomaly detection processing on input data.

The term “machine learning algorithm” refers to a computational procedure that uses data to train a model and to infer outputs, including but not limited to regression algorithms, classification algorithms, clustering algorithms, time-series models, and neural network models.

The term “prediction processing” refers to a computational operation in which the artificial intelligence engine uses a trained model and preprocessed information to estimate future values or unknown values of one or more variables.

The term “anomaly detection processing” refers to a computational operation in which the artificial intelligence engine analyzes data to identify data points, sequences, or patterns that significantly deviate from expected or normal behavior.

The term “prediction results” refers to data output from the prediction processing, including numerical predicted values, prediction intervals, and related indicators.

The term “anomaly detection results” refers to data output from the anomaly detection processing, including anomaly scores, flags indicating anomalous observations, and related indicators.

The term “summary information” refers to data that statistically or logically aggregates prediction results, anomaly detection results, or underlying data, such as summaries per period, per category, or per region, and includes measures such as averages, totals, and rates.

The term “statistical information” refers to quantitative descriptors of data distributions and relationships, such as means, medians, variances, correlations, and frequencies, derived from prediction results, anomaly detection results, or underlying data.

The term “prompt sentence” refers to a sequence of natural-language characters or tokens input by the user through the terminal, which expresses an instruction, question, or request to be processed by a generative AI model.

The term “input data” refers to a structured or semi-structured data set formed by the processor by combining at least the prompt sentence with the summary information and statistical information, for submission to the generative AI model.

The term “generative AI model” refers to a machine learning model, typically a probabilistic or neural network-based language model, which generates new natural-language text or other content by processing input data that includes a prompt sentence and related contextual data.

The term “analysis result” refers to natural-language text generated by the generative AI model, which may include explanations of anomalies, inferred causes, and descriptions of candidate countermeasures, based on the input data.

The term “candidate countermeasures” refers to actions or strategies expressed in natural language that are suggested by the generative AI model as possible responses to detected anomalies or predicted conditions.

The term “report information” refers to a structured data representation that combines prediction results, anomaly detection results, and the analysis result into an integrated format suitable for presentation, storage, or further processing.

The term “display data” refers to data formatted to be rendered by a display device of the terminal, including layout information, textual elements, and visual elements such as graphs and charts.

The term “visual representation” refers to a graphical depiction of data, including at least one of a graph, a chart, a plot, or a diagram, generated from the prediction results, anomaly detection results, or report information.

The term “graph” refers to a two-dimensional or multi-dimensional plot, such as a line graph, bar graph, or scatter plot, used to visually represent one or more quantitative variables over time or across categories.

The term “chart” refers to a structured visual element, such as a bar chart, pie chart, table chart, or heat map, used to visually summarize data relationships or distributions.

The term “behavior information acquired from the terminal” refers to data indicative of how the user interacts with the terminal, including but not limited to input timings, navigation patterns, scrolling behavior, selection operations, and frequency of requests.

The term “emotional state of the user” refers to an estimated psychological or affective condition of the user, such as stress level, confusion, satisfaction, or engagement, inferred from at least the user's input information and behavior information acquired from the terminal.

The term “evaluation results of past candidate countermeasures” refers to data that indicate effectiveness or performance of candidate countermeasures previously generated and applied, including quantitative indicators, user feedback, or outcome metrics.

The term “evaluation index regarding effectiveness of candidate countermeasures” refers to a numerical or categorical measure computed by the processor to quantify how successful a candidate countermeasure has been or is expected to be, based on historical data and evaluation results.

The term “learning data” refers to data supplied to the artificial intelligence engine or the generative AI model for training, fine-tuning, or reinforcement learning, including prediction results, anomaly detection results, prompt sentences, generated responses, and evaluation results.

The term “domain-specific knowledge, experience, and skills” refers to patterns, rules, and operational preferences particular to a given application area, such as business management or operations planning, that are captured in model parameters through training.

In one embodiment, a server, a terminal, and a user cooperate to implement a system that performs data storage, preprocessing, analytical processing, and natural-language generation by using a generative AI model based on a prompt sentence, and that controls presentation of results according to an estimated emotional state of the user.

The server includes at least one processor, a main memory, a non-transitory storage device, and a network interface. The processor may be implemented by a multi-core central processing unit and, in some embodiments, one or more graphics processing units. The storage device may be implemented by a solid-state drive, a hard disk drive, or a redundant storage subsystem. The network interface may be implemented by an Ethernet adapter, a wireless network controller, or another communication device. The server executes an operating system, such as a general-purpose server operating system, and executes middleware and application software modules written, for example, in a general-purpose programming language.

The terminal includes at least one processor, a display device, an input device such as a keyboard or a touch panel, and a communication module. The terminal executes a web browser or a native application that provides a graphical user interface to the user. The terminal communicates with the server by using a protocol such as HTTPS.

The user operates the terminal to input information, upload data files, and provide a prompt sentence in natural language to request analysis or generation of countermeasures. The user reviews prediction results, anomaly detection results, and natural-language output generated by the generative AI model and displayed on the terminal.

The server stores program modules in the storage device. The program modules include at least a data ingestion module, a preprocessing module, an artificial intelligence engine module, a generative AI interface module, an emotional state estimation module, and a visualization and reporting module. Each module is implemented as executable instructions that the processor loads into main memory and executes. The interaction among modules is realized by function calls, inter-process communication, or message queues.

The server uses a database management system running on the server to store structured data. The database management system may be a relational database system with tables, indexes, and transaction control. The server defines tables for raw data, preprocessed data, model outputs, prompt sentences, generated responses, and evaluation results. For example, the server defines a table for sales data including fields such as date, product identifier, region identifier, and sales amount. The server defines a separate table for preprocessed sales data including normalized numeric features and encoded categorical features.

The server uses a data analysis library, such as a numerical array library and a data frame library, to perform preprocessing calculations. The server loads raw records from the database into memory and applies missing-value processing, normalization processing, and outlier processing. The server fills missing values by computing, in the processor, a statistical estimator such as a mean, a median, or an interpolated value, and writing the resulting values back to data structures in memory. The server performs normalization, for example, by calculating for each feature a mean and standard deviation over a training set, and then applying a z-score transformation (subtracting the mean and dividing by the standard deviation) to each data point. These operations improve numerical stability of later machine learning computations and reduce bias caused by differing scales of variables.

The server detects outliers by calculating, for each data point, a deviation measure from a learned distribution or a rule-based threshold. In one embodiment, the server calculates, for each value, a z-score and flags records with a z-score exceeding a predetermined threshold as outliers. In another embodiment, the server applies an isolation forest algorithm implemented in the artificial intelligence engine module, which builds a set of decision trees on randomly selected feature subsets, and calculates an anomaly score as the expected path length for each instance. By applying these specific calculations, the server reduces the influence of extreme values on the learning process and facilitates more accurate prediction and anomaly detection.

The artificial intelligence engine module executed by the server includes at least one machine learning model for prediction and at least one model for anomaly detection. In one embodiment, the server uses a time-series forecasting model based on a recurrent neural network architecture, such as a long short-term memory network. The server defines an input layer that receives sequences of feature vectors representing historical data over a fixed time window, one or more hidden layers with memory cells, and an output layer that outputs predicted values for a future period. The server defines model parameters including weight matrices, bias vectors, and, in some embodiments, regularization parameters. The server trains the model by executing forward propagation to compute predicted outputs, computing an error value by an error function such as mean squared error between predicted outputs and actual targets, and executing backpropagation through time to calculate gradients of the error function with respect to the model parameters. The server updates the parameters by applying an optimization algorithm such as stochastic gradient descent or an adaptive optimization algorithm, with a predetermined learning rate and batch size. These computations are performed using matrix and tensor operations on the processor and, when available, on a graphics processing unit.

In another embodiment, the server uses a statistical time-series model, such as an autoregressive integrated moving average model, as the prediction model. The server estimates parameters by minimizing an information criterion or a likelihood function. This option demonstrates that different algorithmic structures can be embedded in the artificial intelligence engine module while maintaining the same data flow.

For anomaly detection, the server uses either an unsupervised model, such as an isolation forest as mentioned above, or an autoencoder neural network. In the autoencoder case, the server defines an encoder network that maps input feature vectors to a low-dimensional latent representation, and a decoder network that reconstructs the original input from the latent representation. The server trains the autoencoder by minimizing a reconstruction error function, such as mean squared error between input and reconstructed data. The server computes an anomaly score as the reconstruction error for each data point. This approach allows the server to model normal patterns in data and to identify deviating patterns as anomalies in a purely data-driven manner.

The generative AI interface module executed by the server interacts with a generative AI model. The generative AI model may run as an external service accessible over a network, or as a model hosted on the server. In one embodiment, the generative AI model is a large-scale transformer-based language model. The model includes an embedding layer that converts tokens of a prompt sentence and context text into vector representations, multiple transformer blocks each including a multi-head self-attention mechanism and feed-forward sub-layers, and an output projection layer that maps internal representations back to token probabilities. The server provides the generative AI model with an input sequence consisting of a prompt sentence and additional context text including structured prediction results, anomaly detection results, summary information, and statistical information converted into textual form or a compact structured representation.

The server generates input data by constructing, in memory, a concatenated representation that includes at least the user's prompt sentence and a machine-generated summary of numerical results.

For example, the server constructs a context segment of text describing key metrics such as “Total sales increased by X %, anomaly detected in month Y with a deviation of Z standard deviations.” The server then appends the user-provided prompt sentence, such as:

“Using the preprocessed sales data and the latest predictions, identify any months with abnormal sales behavior in the last two years, explain the possible causes, and propose three specific actions to improve next year's sales performance.”

The server encodes this combined text into a sequence of tokens according to a tokenizer associated with the generative AI model, and transmits the encoded sequence to the generative AI model. By performing this structured binding of numerical outputs and prompt sentences, the server ensures that the generative AI model operates on a context that is synchronized with the current analytical state in the database. This leads to improved relevance and accuracy of generated explanations compared with a case where the model receives only an unstructured prompt.

The generative AI model calculates, for each token position, a probability distribution over the vocabulary, based on self-attention computations that relate each token to all preceding tokens, and based on learned parameter matrices in the attention and feed-forward layers. The model generates an analysis result token by token, and the server decodes the tokens into natural-language text. The analysis result includes, for example, identification of specific months as anomalous, hypothesized causes such as seasonality, promotional events, or external factors, and proposed candidate countermeasures such as adjusting inventory planning, altering promotional schedules, or reallocating resources.

The server stores each prompt sentence and each generated analysis result in the database along with metadata such as timestamps, user identifiers, and identifiers of underlying prediction and anomaly detection runs. The server also stores evaluation results of candidate countermeasures, such as performance metrics measured after implementation or user feedback scores. The server uses these records as learning data for additional training or fine tuning of the generative AI model or of smaller models that guide weighting and selection of outputs.

In one embodiment, the server periodically constructs a training set in which each sample includes a prompt sentence, structured analytical context, and a generated response, along with an evaluation label representing effectiveness or user satisfaction. The server trains a supervisory model or adapts the generative AI model by adjusting weights to increase the probability of generating responses that received higher evaluation labels. In another embodiment, the server applies reinforcement learning techniques by defining a reward signal based on evaluation results of countermeasures and updating policy parameters to maximize expected reward. These procedures improve the generative behavior of the model in a manner that depends on domain-specific objectives and computationally optimizes content generation beyond simple static templates.

The emotional state estimation module executed by the server monitors behavior information transmitted from the terminal. The server logs interaction patterns such as time intervals between inputs, frequency of scrolling, repeated viewing of particular charts, and frequency of prompt submissions. The server also analyzes characteristics of user text, such as length, use of certain terms, or correction patterns. The server converts these features into a feature vector and applies a classifier model, such as a logistic regression model or a neural network classifier, previously trained to map behavioral patterns to estimated emotional states like confusion, stress, or engagement. Based on the estimated emotional state, the server selects or modifies user interface content. For example, when the server estimates high confusion, the server automatically generates simplified explanation prompts or suggests to the user shorter prompt templates, thereby reducing cognitive load. Likewise, when high stress is detected, the server may reduce the complexity of simultaneously shown graphs to lower visual overload.

This adaptation is not a mere change in wording for convenience; rather, it allows the server to control the amount and format of data transmitted to the terminal, preventing redundant or overly dense transmissions, and thereby reducing communication load. It also reduces the number of repeated queries that the user might otherwise issue, which lowers processing load on the server. The causal relationship is that the emotional state estimation enables the server to condition the volume and complexity of data processing and transmission on user state, thus improving utilization of computational and network resources.

The visualization and reporting module executed by the server uses a graphics or charting library to define visual specifications for graphs and charts. The server constructs, in main memory, data structures representing series of time-indexed values, category-aggregated metrics, and anomaly markers. The server encodes these structures into a format understood by a client-side chart renderer, such as a JSON configuration for a charting library. The server associates visual indicators, such as colored markers or shaded regions, with anomaly periods identified by the anomaly detection processing. The server then transmits this display data to the terminal, which renders the graphs and charts on the display device. Because the server has already reduced and structured data in an efficient form, the terminal does not need to perform heavy computations, leading to faster rendering and improved responsiveness of the overall system.

In one example, the user uploads past five years of sales data through the terminal. The server stores this data, preprocesses it to handle missing values and normalize features, and trains a forecasting model as described above. The server produces predictions for the next year and detects anomalous months in the past two years. The user then enters the following prompt sentence at the terminal: “Using the preprocessed sales data and the latest predictions, identify any months with abnormal sales behavior in the last two years, explain the possible causes, and propose three specific actions to improve next year's sales performance.”

The server constructs structured context data summarizing predictions and anomalies, binds this structured data to the prompt sentence into a single combined input, and provides this to the generative AI model. The generative AI model generates an analysis result that specifically references months and magnitudes derived from the numerical analysis. The server formats this analysis together with graphs showing anomalies and forecasts, and transmits it to the terminal. The terminal displays a dashboard where the user can see both the graphical time series and the system-generated narrative explanation. By coupling analytical computations with generative output in this way, the system provides synchronized, technically grounded insight that could not be efficiently produced by manual work or purely rule-based templates.

The server improves computer technology in several ways. First, the server reduces redundant data transformations by centralizing preprocessing of raw data with specific algorithms, thereby reducing noise and variance before training. This leads to faster convergence of learning algorithms and lower error on prediction tasks. Second, by structuring analytical outputs and systematically combining them with prompt sentences, the server improves the efficiency with which the generative AI model utilizes computational resources: the model receives precisely targeted, up-to-date context, reducing the number of tokens and prompting iterations needed to obtain a high-quality answer. Third, by logging prompt-response pairs and evaluation results and feeding them back into model adaptation, the server transforms an initially general-purpose model into a domain-optimized component, improving accuracy and reducing the number of interactions required to reach a useful result. Fourth, by estimating the emotional state of the user and adapting content volume and complexity accordingly, the server reduces unnecessary data rendering and transmission, which directly contributes to lower communication load and more efficient use of server and terminal resources.

In addition, the server applies specific non-conventional procedures for integrating predictive machine learning models and generative AI models. Instead of simply running a language model on user prompts, the server builds a separate layer of structured context based on learned numerical models, uses predetermined templates and rule-based conversions to encode numeric outputs into textual or structured context segments, and then attaches these segments as part of the prompt to the generative AI model. This non-standard integration pipeline yields a technical effect: the generative model's internal attention mechanism can attend directly to concrete numerical summaries and anomaly flags, improving the precision and interpretability of the generated text. This is different from merely automating human drafting, because the generative model operates on a computationally curated representation of data that is not ordinarily available to a human in such form.

Various modifications and alternative configurations can be implemented. The server may use different machine learning algorithms, such as gradient boosting decision trees, convolutional neural networks for certain structured data, or graph neural networks for relational data, as long as the server stores and preprocesses data, executes prediction and anomaly detection on preprocessed data, and binds outputs to prompt sentences for generative processing. The generative AI model may be a smaller domain-specific model instead of a large general-purpose model. The emotional state estimation may be simplified to discrete levels based on fewer features or may be enhanced by including biometric data where available. The database structure may be adapted to different domains, such as manufacturing logs, sensor data, or network traffic logs, but the fundamental flow of preprocessing, analytical modeling, generative binding, and adaptive presentation remains consistent.

In all embodiments, the server, the terminal, and the user interact in such a way that the internal data structures, algorithms, and control flows within the server are designed not merely to replicate manual business processes, but to improve the operation of the computer system itself in terms of processing speed, prediction and detection accuracy, data management efficiency, and communication load reduction.

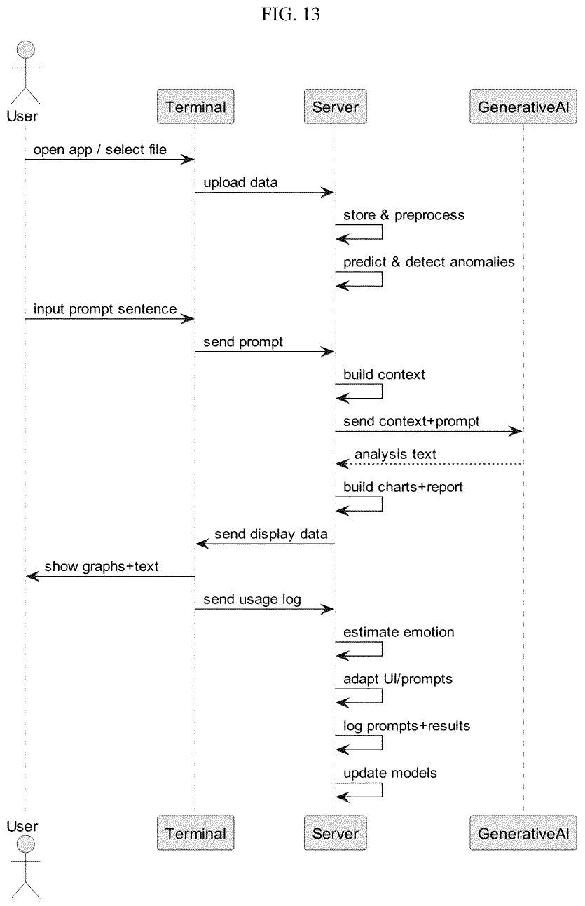

The following describes the processing flow using FIG. 13.

### Step 1

The user prepares business data and a computing environment. The user creates electronic files, such as tables of sales records, customer information, or sensor logs, using spreadsheet software on a local device. The user saves the data as CSV files or spreadsheet files. The user starts a web browser or a dedicated application on the terminal and connects to the server over a network.

Input: Raw business data in file form stored on the user's device.

Output: Files ready for upload and a live connection between the terminal and the server.

### Step 2

The terminal sends the user's data files to the server. The terminal displays an upload screen, allows the user to select one or more files, and issues an HTTPS request containing the selected files to an upload endpoint of the server. The terminal attaches metadata such as file name and user identifier to the request.

Input: User-selected raw data files and associated metadata.

Output: An HTTP request containing the files, transmitted to the server.

### Step 3

The server receives and stores the raw data. The server accepts the incoming HTTP request, validates the file types and sizes, and writes the received files to a temporary directory on a storage device. The server parses each file using a data parsing library, converts textual representations of dates and numbers into internal formats, and inserts the parsed records into one or more tables of a database management system. The server creates or updates indexes on key fields to accelerate later queries.

Input: Uploaded raw data files and metadata from the terminal.

Output: Structured raw records stored in database tables and index structures created in the database.

### Step 4

The server performs preprocessing on the stored data. The server queries the database to retrieve raw records into an in-memory data structure, such as a data frame. The server scans each column to detect missing values, inconsistent formats, and extreme values. The server fills missing numeric values using a chosen rule, such as replacing them with the mean or median of neighboring records, and standardizes date values into a unified format. The server normalizes numeric features by computing a mean and standard deviation for each feature and applying a z-score transformation.

The server identifies outliers by computing a deviation measure, such as a z-score or an isolation forest anomaly score, and flags or filters records whose scores exceed a threshold. The server writes cleaned and normalized records into a separate preprocessed-data table.

Input: Raw records read from the database tables.

Output: Preprocessed records stored in a preprocessed-data table, including normalized values and outlier flags.

### Step 5

The server trains or updates a prediction model using the preprocessed data. The server selects preprocessed records for a training period and splits them into training and validation subsets based on time or other criteria. The server constructs a model architecture, such as a recurrent neural network for time-series forecasting, by defining layers, weight matrices, and activation functions.

The server repeatedly performs forward passes to compute predictions and backward passes to compute gradients of an error function, such as mean squared error, with respect to model parameters. The server updates the parameters using an optimization algorithm with a defined learning rate and batch size. The server stores the trained model parameters in the storage device.

Input: Preprocessed records from the preprocessed-data table.

Output: Trained prediction model parameters stored in the storage device.

### Step 6

The server performs prediction processing using the trained model. The server retrieves the latest preprocessed records for the prediction horizon, formats them into sequences or feature vectors required by the model, and loads the trained model parameters into memory. The server executes forward propagation through the model to compute predicted future values, such as predicted sales for future time steps. The server computes additional statistics, such as confidence intervals or error estimates, if configured. The server writes the prediction results into a prediction-results table with fields indicating time, predicted value, and optional confidence metrics.

Input: Preprocessed records for the prediction horizon and trained model parameters.

Output: Prediction results stored in the prediction-results table.

### Step 7

The server performs anomaly detection processing on historical or recent data. The server selects preprocessed records over a target period and loads them into memory. The server applies an anomaly detection algorithm, such as an isolation forest or an autoencoder, by computing anomaly scores for each record. The server compares each anomaly score to a threshold and labels records as normal or anomalous accordingly. The server stores anomaly information, including timestamps, anomaly scores, and labels, in an anomaly-results table.

Input: Preprocessed records for the anomaly detection period and parameters of the anomaly detection model.

Output: Anomaly detection results stored in the anomaly-results table with scores and labels.

### Step 8

The server aggregates prediction and anomaly results into structured summaries. The server issues database queries to retrieve prediction results and anomaly detection results for relevant time windows and categories. The server computes summary metrics, such as averages, totals, growth rates, counts of anomalies per period, and maximum deviation values, using vectorized operations on the processor. The server compiles these metrics into summary information and statistical information data structures. The server stores or caches these summaries for repeated use in subsequent steps.

Input: Prediction-results table entries and anomaly-results table entries.

Output: Summary information and statistical information representing aggregated analytical results.

### Step 9

The user formulates and inputs a prompt sentence. The user reviews the current business context and decides on a question or task to be addressed by the generative AI model. The user types a natural-language instruction into an input field displayed on the terminal, for example:

“Using the preprocessed sales data and the latest predictions, identify any months with abnormal sales behavior in the last two years, explain the possible causes, and propose three specific actions to improve next year's sales performance.”

The user submits the prompt sentence, and the terminal sends it to the server via an HTTPS request or a persistent communication channel.

Input: The user's natural-language prompt sentence entered on the terminal.

Output: A request message containing the prompt sentence transmitted to the server.

### Step 10

The server constructs combined input data for the generative AI model. The server receives the prompt sentence from the terminal and logs it in a prompt-history table together with a user identifier and a timestamp. The server retrieves the relevant summary information and statistical information from the storage device based on keywords or requested time periods inferred from the prompt. The server formats these analytical results into a compact textual or structured representation, such as short explanatory sentences or key-value listings. The server concatenates the formatted analytical context and the prompt sentence into a single text block or structured object, forming input data that encodes both user intent and current analytical state.

Input: Prompt sentence from the terminal and summary/statistical information from the server's storage.

Output: Combined input data containing analytical context and the prompt sentence, ready for processing by the generative AI model.

### Step 11

The server invokes the generative AI model with the combined input data. The server tokenizes the combined text according to a tokenizer associated with the generative AI model, converts tokens into numerical embeddings, and sends the resulting sequence to the generative AI model, either via an internal call or via an external API. The generative AI model processes the sequence by computing self-attention scores, updating internal hidden states, and generating output token probabilities at each step. The server repeatedly samples or selects tokens according to the probability distribution until an end condition is reached. The server decodes the sequence of output tokens into natural-language text, which constitutes an analysis result.

Input: Tokenized combined input data including the prompt sentence and analytical context.

Output: Natural-language analysis result text generated by the generative AI model.

### Step 12

The server associates the generated analysis result with analytical outputs and stores them. The server links the analysis result to the corresponding prediction and anomaly detection results through identifiers and timestamps. The server writes the analysis result, together with references to the prompt sentence, user, and underlying analytical run identifiers, into a response-history table. If evaluation information later becomes available, the server will append evaluation results to the same record.

Input: Natural-language analysis result and identifiers of related analytical outputs.

Output: Stored association among prompts, analyses, prediction results, and anomaly results in the database.

### Step 13

The server generates display data including textual and visual elements. The server retrieves prediction results, anomaly markers, and portions of the analysis result from the database. The server builds chart configurations in memory that map numerical series and anomaly points to visual elements such as line graphs, bar charts, and highlighted regions. The server embeds the analysis result text as captions, explanations, or report sections. The server creates display data structures that include chart definitions, textual blocks, and layout information for rendering on the terminal.

Input: Prediction results, anomaly results, and analysis result stored in the database.

Output: Display data containing chart configurations and explanatory text ready to be transmitted to the terminal.

### Step 14

The terminal renders the display data and presents it to the user. The terminal receives the display data from the server via an HTTP response or another communication mechanism. The terminal uses a rendering engine or a charting library to draw graphs and charts on the display device based on the configurations received from the server. The terminal arranges textual analysis sections near or below the corresponding visualizations. The user views the displayed information, reads the generated explanations, and interacts with charts using scrolling, zooming, or selection gestures.

Input: Display data including chart definitions and textual content received from the server.

Output: Rendered visual and textual presentation on the terminal's display for the user.

### Step 15

The server estimates the emotional state of the user based on interaction behavior. The server receives behavioral logs from the terminal, including timestamps of actions, navigation events, repeated viewings, and prompt submission frequencies. The server converts these behavioral features into numerical feature vectors and applies an emotional state classifier, such as a trained logistic regression model or neural network, to infer an emotional state label or score. The server records the estimated emotional state in association with the current session and the latest prompt and response.

Input: Behavioral interaction data from the terminal and a trained emotional state classification model.

Output: An estimated emotional state value or label stored in the server.

### Step 16

The server adapts subsequent prompts and presentations based on the estimated emotional state. The server evaluates the current emotional state and selects a presentation strategy, such as simplifying explanations, adding more detail, or reducing the number of simultaneously displayed charts. The server may generate suggested prompt templates tailored to the user's state, for example, shorter and more focused prompt sentences when confusion is detected. The server adjusts the amount and type of data included in the next display data, thereby modulating communication load and processing complexity.

Input: Estimated emotional state and current analytical and interaction context.

Output: Modified or suggested prompt templates and adjusted display data parameters for future interactions.

### Step 17

The server updates models using historical prompt-response and evaluation data. The server periodically retrieves stored prompt sentences, analysis results, evaluation results of candidate countermeasures, and associated analytical outputs from the database. The server constructs training examples in which inputs include prompt sentences and structured analytical context, and outputs include generated responses and evaluation labels. The server feeds these examples into a training procedure for a supervisory or reinforcement-learning component, adjusting parameters to increase the likelihood of generating responses that historically received favorable evaluation. The server then deploys the updated parameters to influence future generative processing or countermeasure selection.

Input: Historical prompt sentences, analysis results, analytical outputs, and evaluation results from the database.

Output: Updated model parameters for the generative AI model or auxiliary models that improve response quality and countermeasure effectiveness.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented monitoring and management systems are typically configured as a loose collection of independent components for data collection, visualization, anomaly detection, and rule-based alerting. In many such systems, a central processor merely aggregates sensor readings and user inputs, performs simple threshold checks, and renders dashboards. These architectures suffer from several technical shortcomings.

First, the processor usually treats anomaly detection and countermeasure planning as separate, manually bridged stages. The processor may detect anomalous values using fixed thresholds or simple statistical logic, but the generation of remedial actions often relies on human operators who must manually interpret dashboards and compose responses. This separation increases processing latency, leads to inconsistent decisions, and prevents the processor from fully exploiting machine learning models for closed-loop control.

Second, existing systems rarely integrate generative artificial intelligence models into the core processing flow in a structured manner. In many cases, a generative model, if used at all, is invoked ad hoc by a user who manually crafts a free-form prompt. The processor does not automatically construct machine-readable, context-rich prompt sentences from internal data structures such as integrated time-series, feature vectors, detected anomaly patterns, and inferred root-cause information. As a result, the generative model cannot reliably access the relevant low-level operational data, and its outputs are not systematically translated into executable countermeasure plans. This lack of integration limits both the quality of generated countermeasures and the degree to which the generative model can technically improve system behavior.

Third, typical systems do not implement an end-to-end data pathway that converts generative model responses into optimized, machine-actionable plans. Model outputs are often presented to the user as unstructured text, requiring manual interpretation. The processor does not parse the generated content, does not map it into structured action items, and does not apply mathematical optimization algorithms to determine execution order and timing under resource and schedule constraints. This results in underutilization of computational resources and prevents the system from achieving consistent, high-throughput, and low-latency decision-making.

Fourth, emotion-related data from imaging and acoustic devices are usually processed, if at all, in a separate user-experience subsystem. Existing architectures do not tightly couple user emotion recognition with core anomaly handling and countermeasure planning. The processor typically does not recognize emotion states and does not dynamically adapt prompt sentences, generative AI invocations, or interface presentations according to user cognitive load or stress level. This separation impairs the ability of the processor to tailor the complexity, timing, and presentation of recommendations to the user's current state, which can degrade operator performance and increase error rates.

Fifth, many known systems lack continuous, technically structured feedback from executed countermeasures to both discriminative machine learning models and generative artificial intelligence models. Even when post-intervention results are stored, the processor often does not use them as labeled training signals to refine anomaly models and to update the generative model's behavior. As a consequence, the system remains static, cannot adapt to evolving equipment, environments, or usage patterns, and cannot improve its predictive and prescriptive performance over time.

Accordingly, there is a need for a computer-centric architecture in which a processor is specifically configured to (i) integrate heterogeneous time-series and user input data, (ii) compute feature values and anomaly indices, (iii) infer root causes, (iv) automatically construct structured prompt sentences for a generative artificial intelligence model, (v) parse and structurally interpret the model's responses into concrete countermeasure items, (vi) perform optimization calculations to determine an execution order and timing of countermeasures, and (vii) recognize user emotion and feed emotion state information back into both the prompt construction and the presentation and adaptation of countermeasure plans. Such an architecture improves the functioning of the computer system itself by creating a closed, technically interoperable loop between data acquisition, machine learning, generative reasoning, and interface behavior, thereby reducing processing latency, increasing decision quality, and enabling adaptive behavior that cannot be achieved by conventional rule-based or manually integrated systems.

The specific processing by the specific processing unit 290 of the data processing device 12 in Application Example 2 is realized by the following means.

The present invention provides a server comprising a processor configured to integrate, in a storage unit, time-series operation information obtained from observation devices and user input information, to generate feature values based on the integrated information, to calculate anomaly indices from temporal changes of the feature values, to detect anomalies based on the anomaly indices, to perform statistical or causal analysis on the integrated information and the anomaly indices to specify cause information, to automatically generate a prompt sentence in natural language from the cause information and the integrated information, to input the prompt sentence into a generative artificial intelligence model and acquire a response including at least one countermeasure proposal, to parse the response and extract concrete countermeasure content, to perform an optimization calculation that determines at least one of an execution order and an execution timing of the countermeasure content and outputs countermeasure plan information, and to analyze emotion-related data acquired from at least one imaging device and at least one sound acquisition device to recognize a user emotion, generate emotion state information, and adjust at least one of generation of the prompt sentence, the countermeasure plan information, and a user interface presentation in accordance with the emotion state information. This enables the computer system itself to execute an end-to-end, closed-loop process in which heterogeneous operational and emotion-related data are fused, anomalies are detected with learned models, context-rich prompt sentences are generated and supplied to a generative AI model without human intervention, AI responses are converted into optimized and scheduled countermeasure plans, and those plans and their presentations are dynamically adapted to user emotional state, thereby improving computational efficiency, reducing decision latency, enhancing robustness and accuracy of anomaly handling, and providing an adaptive human-machine interface that is technically integrated with the system's core data processing and control functions.

The term “processor” refers to one or more hardware processing units, such as central processing units or graphics processing units, and associated control circuitry that are configured to execute instructions of one or more computer programs.

The term “system” refers to an arrangement including at least the processor, one or more storage units, one or more input devices, and one or more output devices that cooperate to perform information processing as claimed.

The term “user input information” refers to information that is explicitly provided by a human operator through an input device, such as a keyboard, pointer device, touchscreen, or microphone, including textual input, commands, and spoken utterances.

The term “operation information” refers to information representing states or behaviors of physical or logical resources, such as equipment status, sensor measurements, performance metrics, or log entries, that is acquired from observation devices.

The term “observation device” refers to any device that senses or records a physical or logical quantity related to a monitored object or process, including but not limited to sensors, controllers, network interfaces, and logging modules.

The term “time-series manner” refers to the organization of information into sequences indexed by time, such that each record includes a timestamp and can be ordered or processed according to its temporal position.

The term “storage unit” refers to any non-transitory computer-readable medium, such as a semiconductor memory, magnetic storage, or optical storage, that holds data and instructions for access by the processor.

The term “integrated information” refers to information that results from aggregating, aligning, and combining multiple sources of user input information and operation information into a unified data structure.

The term “feature value” refers to a derived numerical or categorical value computed from raw or integrated information and used as an input to analysis, learning, or decision-making algorithms.

The term “visual representation” refers to a graphical or symbolic expression of data, such as charts, graphs, icons, or annotated indicators, that can be rendered on a display to convey information to a user.

The term “display unit” refers to a hardware device, such as a monitor, panel, or head-mounted display, capable of presenting visual information as controlled by the processor.

The term “temporal change” refers to a variation over time in one or more feature values or other data elements when observed in a time-ordered sequence.

The term “anomaly index” refers to a numerical or symbolic indicator computed from feature values that quantifies the degree to which observed data deviates from a reference pattern or expected behavior.

The term “anomaly” refers to a state in which the anomaly index or related criteria indicate that data significantly deviate from normal or expected ranges or patterns.

The term “statistical analysis” refers to a process in which statistical methods, such as correlation analysis, regression, clustering, or hypothesis testing, are applied to data to derive relationships, patterns, or summaries.

The term “causal analysis” refers to a process in which methods intended to infer potential cause-and-effect relationships between variables, such as causal modeling or temporal dependency analysis, are applied to data.

The term “cause information” refers to information specifying one or more factors that are inferred to be responsible for an anomaly or abnormal behavior.

The term “prompt sentence” refers to a natural-language text string constructed by the processor that encodes context, problem description, and request content, and that is intended as input to a generative artificial intelligence model.

The term “generative artificial intelligence model” refers to a machine-implemented model, trained using machine learning techniques, that produces new data or content, such as text or structured recommendations, in response to input information.

The term “response” refers to output data generated by the generative artificial intelligence model in reply to a prompt sentence, and may include explanatory text, recommended actions, or structured values.

The term “countermeasure proposal” refers to information contained in the response that describes one or more actions or strategies intended to address an anomaly or its inferred cause.

The term “concrete countermeasure content” refers to specific, executable action items, parameters, or procedures that are extracted from a countermeasure proposal and can be implemented in an operational environment.

The term “optimization calculation” refers to a computational procedure in which the processor determines values of decision variables, such as execution order or execution timing, that satisfy constraints while optimizing at least one objective function.

The term “execution order” refers to a sequence in which multiple countermeasure actions are to be carried out.

The term “execution timing” refers to one or more time points or intervals at which specific countermeasure actions are scheduled to be performed.

The term “countermeasure plan information” refers to structured data describing at least an execution order or execution timing of countermeasure content, and optionally including resource assignments or dependencies.

The term “imaging device” refers to any device capable of acquiring image data of at least part of a user or environment, such as a camera, image sensor, or video capture unit.

The term “sound acquisition device” refers to any device capable of detecting and converting sound into an electronic signal, such as a microphone or an array of acoustic sensors.

The term “emotion-related data” refers to data derived from observations of a user, including image data, audio data, or other signals, that is usable to estimate an emotional state of the user.

The term “user emotion” refers to an internal affective state of a user, such as stress, satisfaction, interest, or confusion, as inferred by the processor from emotion-related data.

The term “emotion state information” refers to information representing an estimated user emotion, including at least one emotion category or dimension and optionally an associated confidence or intensity.

The term “user interface presentation” refers to visual, auditory, or other output content generated by the system for display or playback to a user by at least one output device.

The term “learning information” refers to data used for training or updating a machine learning model, including past operation case data, anomaly case data, and countermeasure execution result data.

The term “past operation case data” refers to stored records describing historical operation conditions, inputs, and outputs of a monitored system during normal or abnormal operation.

The term “anomaly case data” refers to stored records that describe historical instances of anomalies, including associated sensor values, context, and labels.

The term “countermeasure execution result data” refers to stored records describing the outcome of previously executed countermeasures, including whether anomalies were mitigated and how performance metrics changed.

The term “learning control” refers to a process in which the processor manages training, retraining, or parameter updating of a machine learning model using learning information.

The term “machine learning algorithm” refers to a computational procedure that adjusts parameters of a model based on data so that the model can perform tasks such as prediction, classification, or anomaly detection.

The term “prediction information” refers to information output by a machine learning algorithm that estimates future values, states, or outcomes based on current or past data.

The term “integrated reasoning” refers to a process in which the processor combines outputs from multiple models or algorithms, such as a generative artificial intelligence model and a discriminative machine learning model, to produce a refined or corrected result.

In one embodiment, a server executes an integrated program on a hardware platform including at least one central processing unit, at least one volatile memory, at least one non-volatile storage device, and at least one network interface. The server runs an operating system such as a generic server operating system and middleware including an HTTP server, a database management system, and an application framework. The server cooperates with at least one terminal operated by a user. The terminal includes an imaging device, a sound acquisition device, an input interface, and a display interface. The terminal communicates with the server through a communication network.

The server stores an application program that implements the claimed functions in the form of multiple software modules. The server stores the application program and intermediate data in a relational database, a time-series database, or an equivalent storage system.

The server uses a general-purpose scripting language runtime, a numerical computation library, and a data-frame handling library (for example, a language interpreter, a mathematical library, and a table manipulation library) to implement feature extraction, anomaly index computation, and statistical or causal analysis. The server uses a machine learning framework (for example, a tensor computation framework) to implement both discriminative models (for anomaly detection and prediction) and a generative AI model (for countermeasure proposal). The server optionally uses an optimization solver library (for example, a mathematical programming solver) to compute an optimal execution order and timing of concrete countermeasures. The server can use visualization software (for example, a dashboard engine) to render visual representations.

In a representative configuration, the server executes distinct logical modules, including: a data acquisition module, a data integration module, a feature computation module, an anomaly detection module, a cause analysis module, a prompt generation module, a generative AI interface module, a response parsing module, an optimization module, an emotion analysis module, and a user interface adaptation module. Each module is implemented as a set of computer-executable instructions stored on a non-transitory computer-readable medium.

The server acquires operation information from observation devices such as temperature sensors, pressure sensors, vibration sensors, position encoders, programmable controllers, and logging modules. The observation devices supply measurements as digital signals. The server receives these measurements through fieldbus gateways, industrial protocol adapters, or network interfaces. The server also receives user input information that is entered by the user at the terminal through key presses, pointing operations, or speech input captured by the microphone.

The server integrates the various data streams into a unified time-series data structure. The server uses a table structure having fields including at least: timestamp, device identifier, variable name, raw value, and quality flag. The server stores these records in a time-ordered manner. The server resamples heterogeneous sensor data to a uniform time grid by interpolation or aggregation, for example by computing the average or maximum value within each fixed-length time bin. The server associates user input information with nearby time windows and device identifiers. By doing so, the server constructs integrated information that can be processed by later modules using consistent indices and efficient queries.

The server computes feature values from the integrated information. The server generates, for each monitored unit (such as a specific machine or logical subsystem), feature vectors that may include, for example, rolling mean, rolling standard deviation, exponentially weighted moving average, autocorrelation coefficients, and spectral energy in certain frequency bands of the vibration signal.

The server optionally includes categorical encodings such as shift identifier, product type identifier, and operator group identifier. The server represents each feature vector as an array of numeric values and stores it in a feature table. This concrete data structure enables efficient batch operations and matrix multiplications within the machine learning framework.

The server generates visual representations based on the feature data and raw measurements. The server issues queries to the database to obtain time-series for selected variables and then transmits the result to a visualization engine. The visualization engine renders line charts, bar charts, and heatmaps. The server controls the visualization engine through configuration files or application programming interfaces, thereby instructing it to present key indicators and anomaly indices.

The server computes anomaly indices using a trained machine learning model. In one embodiment, the server uses an Isolation Forest algorithm implemented in a machine learning library. The server treats each feature vector as an input instance and obtains, for each instance, an anomaly score between 0 and 1. The server treats a score above a threshold (for example, 0.7) as an indication of an anomaly. The server stores the anomaly index alongside the feature vector and marks the corresponding time range and device as anomalous. In another embodiment, the server uses an autoencoder neural network with an encoder-decoder architecture and a bottleneck layer. The server trains the autoencoder on historical normal data by minimizing reconstruction error using a mean squared error loss function and an optimizer such as stochastic gradient descent or adaptive moment estimation. The server later computes anomaly indices as reconstruction errors for new data; a large reconstruction error indicates an out-of-distribution condition. Because the server uses high-dimensional feature vectors and non-linear mappings that a human operator cannot feasibly evaluate in real time, the anomaly detection function is not a mere automation of human work but exploits computer-specific capabilities such as fast vectorized computation and large-scale pattern recognition.

The server performs cause analysis by combining statistical and temporal methods. The server computes correlation coefficients between anomaly indices and individual feature components across historical windows. The server identifies variables whose correlation magnitude exceeds a threshold. The server additionally applies a causal analysis method, such as a Granger causality test, over time-lagged feature sequences. The server evaluates whether past values of a particular variable improve the prediction of current anomaly indices beyond what is explained by past indices alone.

The server records variables that satisfy causality significance criteria as candidate causes. By using such time-series modeling and hypothesis testing, the server can identify subtle root-cause relations that are not apparent from simple threshold violations or static rules.

The server constructs a prompt sentence in natural language for a generative AI model by combining the cause information, the anomaly context, and additional integrated information. The server prepares a template including sections for description of the monitored unit, the time period, key feature deviations, candidate causes, and requested output structure. The server fills this template with specific values drawn from the integrated information and the analysis results. For example, the server can construct a prompt sentence such as:

“Based on the last 2 hours of sensor data, Machine M-45 shows increasing vibration on the X axis and a corresponding rise in defect rate for Product P-10. Past similar cases suggest bearing wear. As a generative AI model, analyze likely root causes and propose a step-by-step maintenance and production-schedule adjustment plan that minimizes downtime.”

The server may further adjust the prompt sentence based on user emotion state, as described below, to ask the generative AI model to provide more condensed or more detailed guidance.

The server interfaces with a generative AI model that is implemented, for example, as a sequence-to-sequence neural network or a transformer-based language model. In one embodiment, the generative AI model comprises multiple layers of attention blocks, each including multi-head self-attention and feed-forward sublayers. The server stores the model parameters on a high-capacity memory device and executes forward inference computations by performing matrix multiplications and non-linear activations over token embeddings representing the prompt sentence. The server feeds the prompt sentence as a sequence of tokens into an encoder and obtains contextualized representations. The server then applies a decoder stack that generates an output sequence token by token, conditioned on the encoder output and previously generated tokens. The server uses a vocabulary and a tokenization scheme (for example, a subword encoding) to convert between text and token sequences.

The server configures the generative AI model with specific hyperparameters, such as number of layers, number of attention heads, embedding dimension, and context window length. The server stores learning information in the form of operation case data, anomaly case data, and countermeasure execution result data. The server uses these data to fine-tune the generative AI model by performing gradient-based optimization. During training, the server minimizes a loss function that may include a language modeling component (for next token prediction) and a task-specific component (for example, a penalty for recommending countermeasures that historically yielded poor outcomes). The server updates the model weights using backpropagation and an optimizer such as adaptive moment estimation. The server periodically repeats this learning control process to incorporate new case data, thereby increasing the relevance and accuracy of generated countermeasure proposals.

The server parses the response produced by the generative AI model. The server receives a sequence of tokens from the decoder, converts it to a text string, and then applies natural language processing to extract structured content. The server uses entity recognition and pattern matching to identify proposed actions, such as “reduce feed rate by 10%,” “replace bearing on axis X,” or “schedule preventive maintenance within 24 hours.” The server records the extracted actions in a countermeasure table that includes fields such as action type, affected unit, parameter values, estimated duration, and precedence relations.

The server performs optimization calculations on the extracted countermeasure content. The server formulates a scheduling problem in which decision variables represent whether to execute a given action during a particular time interval. The server defines an objective function that minimizes a combination of expected downtime, maintenance cost, and impact on throughput. The server imposes constraints representing resource availability, safety conditions, and operational calendars.

The server invokes a mathematical programming solver to solve this optimization model and get an execution order and timing for each action. The server outputs countermeasure plan information, for example in the form of a list of actions, start times, end times, and responsible roles. This technical scheduling process uses the generative AI model's unstructured proposal only as an initial suggestion and then refines it through deterministic optimization, which leads to reproducible and globally consistent plans.

The server processes emotion-related data to recognize user emotion. The terminal captures images of the user's face and audio of the user's voice. The terminal transmits these data to the server. The server pre-processes the images by detecting facial landmarks and normalizing orientation. The server extracts visual features such as distances and angles between facial key points or uses a convolutional neural network to compute feature maps. The server extracts audio features such as Mel-frequency cepstral coefficients and pitch contours from the voice signal. The server concatenates these feature vectors and feeds them to a classifier, which can be a neural network with fully connected layers or a support vector machine. The server outputs an emotion state label (for example, “stressed,” “calm,” “confident”) and a confidence score. The server stores this emotion state information with a timestamp and associates it with the current tasks or interface elements.

The server uses the emotion state information to adjust system behavior. When the emotion analysis module indicates that the user is stressed, the server may generate shorter, more step-by-step prompt sentences and limit the number of alternative options requested from the generative AI model. The server may also simplify the user interface presentation by hiding non-critical graphs, highlighting only essential actions, and avoiding excessive notifications. When the emotion analysis indicates the user is calm and experienced, the server can request more detailed technical justifications from the generative AI model and present richer sets of diagnostic charts. In this way, the server dynamically adapts prompt generation, generative inference, and output presentation according to an objective measure of the user's cognitive state, which is not a conventional manual customization but a technically determined adaptation based on sensory inputs and machine learning.

The server implements several variants of the generative AI interaction. In one variant, the server constructs a prompt sentence that explicitly requests cause identification and remedy synthesis, as exemplified above. In another variant, the server constructs a prompt sentence such as: “As a generative AI model, analyze the possible causes of frequent temperature spikes on Machine B-23, and propose diagnostic steps and corrective actions to stabilize the readings.”

The server sends this prompt sentence to the generative AI model when the user enters a free-text description via the terminal indicating frequent temperature spikes. The server then combines the resulting countermeasure proposals with its own anomaly indices and prediction information from a discriminative model to reconcile or correct the plan. For instance, when the discriminative model predicts that certain actions will not reduce anomaly indices significantly, the server reduces the weight of those actions in the optimization problem.

In another variant, the server automatically constructs a prompt sentence when repeated anomalies with similar patterns are detected. For example, the server may use:

“A vibration sensor on the main spindle of Line 2 shows an increasing trend compared to the last month's baseline. Suggest diagnostic steps, potential component faults, and a maintenance schedule that minimizes production downtime.”

The server in this case does not wait for explicit user input but triggers the generative AI model as an internal autonomous reaction to machine-recognized patterns.

The server thus uses the generative AI model in combination with discriminative models and optimization algorithms, forming a hybrid reasoning architecture. The server implements non-conventional processing sequences in which model outputs are not merely displayed but interpreted, structured, and further processed. This architecture improves computer technology by enabling complex, high-dimensional analytics and generative reasoning to be executed in real time or near real time, with minimal human intervention and with systematic feedback loops that refine both generative and discriminative models over time.

The server supports multiple deployment configurations. In one configuration, the generative AI model resides on the same hardware as the other modules, using local graphics processing resources to perform the heavy linear algebra operations. In another configuration, the server sends the prompt sentence and structured context over a secure network to an external computing resource that hosts the generative AI model and receives the response through an application programming interface. In both cases, the server maintains a log of prompt sentences and corresponding responses in a dedicated table to support auditability, retraining, and debugging.

The terminal provides a graphical interface in which the user can review anomaly indices, cause information, countermeasure plans, and emotion state indicators. The terminal displays, for example, a panel showing current anomaly scores per machine, a timeline of upcoming maintenance tasks from the countermeasure plan information, and a status icon indicating the recognized user emotion.

The terminal enables the user to confirm or modify the proposed plan. When the user modifies actions manually, the server captures the modifications, updates its case data, and uses them as additional supervision signals in future training.

The system produces technical effects that go beyond generic data processing. By representing sensor data as high-dimensional feature vectors and by using non-linear machine learning models, the server can detect anomalies with higher precision and fewer false positives compared to simple threshold rules. By constructing prompt sentences directly from internal structured data, the server ensures that the generative AI model operates with complete and precise context, thereby generating more accurate and relevant countermeasure proposals. By parsing these proposals into structured action items and applying optimization algorithms, the server converts them into executable plans that respect real-world constraints, which reduces computation of redundant or conflicting actions.

By integrating emotion recognition into prompt generation and interface adaptation, the server reduces cognitive overload and user errors, leading to faster response time and fewer misinterpretations. Furthermore, by feeding back post-execution outcomes into both generative and discriminative models, the server incrementally improves model parameters and decision policies over time, thus continuously enhancing computational efficiency and decision quality.

In summary, the server, the terminal, and the user cooperate in a configuration where the server performs technically concrete steps of data structuring, feature computation, anomaly index calculation, statistical and causal analysis, prompt sentence generation, generative AI model invocation, structured response parsing, optimization of countermeasure execution, and emotion-aware interface control. This configuration yields a computer-implemented system that is not limited to abstract information processing but is technically tied to observation devices, actuated schedules, and emotion-adaptive user interfaces, and that improves the functioning of the computer itself by enabling complex, context-rich, and closed-loop control processes that cannot be achieved by conventional architectures or by mere human mental steps.

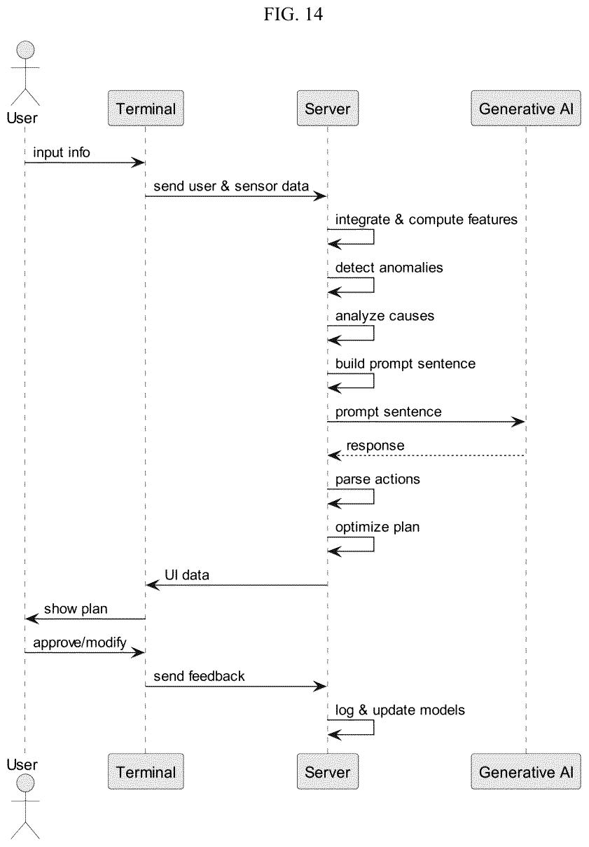

The following describes the processing flow using FIG. 14.

### Step 1

Server acquires raw data from observation devices and terminals.

Server uses network interfaces to receive operation information from sensors, controllers, and logging modules, and to receive user input information from Terminal.

Input: raw sensor values (for example, temperature, pressure, vibration, machine status), timestamps, device identifiers, and user input text or commands.

Server parses incoming messages, validates formats, attaches timestamps if missing, and writes each record into a raw data table with fields {timestamp, device_id, variable_name, raw_value, quality_flag}.

Output: a time-stamped raw data set stored in a storage unit.

### Step 2

Server integrates heterogeneous data into a unified time-series structure.

Input: raw data records from the raw data table and user input records from a user input table.

Server groups records by device identifier and variable name, resamples each group to a uniform time grid (for example, 1-second or 1-minute intervals) using averaging or interpolation, and aligns user input records with corresponding time windows and devices.

Server constructs integrated records with fields {timestamp, device_id, variable_name, integrated_value, source_type}, and inserts them into an integrated data table.

Output: an integrated time-series data set that combines operation information and user input information.

### Step 3

Server computes feature values from the integrated information.

Input: integrated time-series data from the integrated data table for a specified time horizon and set of devices.

Server slides a fixed-length window (for example, 10 minutes) across the time-series for each device, and within each window computes statistical and spectral features such as mean, variance, exponentially weighted moving average, autocorrelation coefficients, and frequency-band energies.

Server forms a feature vector for each window, assigns a unique feature_id, and stores records with fields {feature_id, timestamp_range, device_id, feature_vector} in a feature table.

Output: a feature data set consisting of feature vectors indexed by device and time range.

### Step 4

Server visualizes selected variables and feature values for monitoring.

Input: raw and integrated data from the integrated data table and feature vectors from the feature table, as selected by a visualization configuration.

Server queries time-series segments for target variables, converts them into a format expected by a visualization engine, and sends the data to the visualization engine through an application programming interface.

Server instructs the visualization engine to generate charts such as line plots for temperatures, bar charts for defect counts, and trend lines for feature values.

Output: visual representations rendered on a display unit, which Terminal presents to User through a graphical user interface.

### Step 5

Server detects anomalies by applying a machine learning model to feature values.

Input: feature vectors from the feature table corresponding to the most recent time windows.

Server loads a pre-trained anomaly detection model (for example, an Isolation Forest or an autoencoder) from storage, and passes each feature vector as input to the model.

Server computes anomaly scores (for example, reconstruction error or isolation depth) and compares each score to a threshold.

Server marks feature vectors with scores above the threshold as anomalous and writes records with fields {anomaly_id, feature_id, device_id, timestamp_range, anomaly_score, anomaly_flag} into an anomaly table.

Output: an anomaly data set indicating which feature windows and devices exhibit anomalous behavior.

### Step 6

Server performs statistical and causal analysis to infer candidate causes of anomalies.

Input: anomaly records from the anomaly table and corresponding feature vectors and integrated data from the feature and integrated data tables.

Server selects time segments around each anomaly, extracts time-aligned sequences of feature components, and computes correlation coefficients between each component and the anomaly_score.

Server additionally computes time-lagged relationships (for example, using Granger causality tests) to evaluate whether past values of particular variables help predict current anomaly scores.

Server identifies variables whose correlation and causality measures exceed pre-defined thresholds and forms cause entries with fields {cause_id, anomaly_id, device_id, variable_name, importance_score}.

Output: cause information stored in a cause table listing candidate root-cause variables with associated scores.

### Step 7

Server constructs a prompt sentence for a generative AI model based on anomaly and cause information.

Input: anomaly records from the anomaly table, cause information from the cause table, and integrated operational context from the integrated data table.

Server retrieves relevant anomaly details, such as magnitude and duration, retrieves top-ranked cause variables, and retrieves contextual details such as affected product type or operational mode.

Server fills a natural-language template with these values to create a context-rich prompt sentence.

For example, Server generates a prompt sentence:

“Based on the last 2 hours of sensor data, Machine M-45 shows increasing vibration on the X axis and a corresponding rise in defect rate for Product P-10. Past similar cases suggest bearing wear. As a generative AI model, analyze likely root causes and propose a step-by-step maintenance and production-schedule adjustment plan that minimizes downtime.”

Server stores the generated prompt sentence in a prompt log table with fields {prompt_id, anomaly_id, text}.

Output: a prompt sentence and associated prompt_id recorded for later use.

### Step 8

Server adjusts the prompt sentence according to user emotion, if available.

Input: base prompt sentence from the prompt log table and emotion state information from an emotion table.

Server retrieves the user's current or recent emotion state (for example, stressed, calm, or uncertain) and associated confidence.

Server modifies the prompt sentence content or style, for instance by adding a requirement for simpler, shorter instructions if the user is stressed, or for more detailed technical explanation if the user is calm and experienced.

Server updates the prompt text in the prompt log table under the same prompt_id.

Output: an emotion-adapted prompt sentence ready for submission to the generative AI model.

### Step 9

Server submits the prompt sentence to the generative AI model and acquires a response.

Input: the final prompt sentence text from the prompt log table.

Server tokenizes the prompt sentence into input tokens according to the vocabulary of the generative AI model, transmits the tokens and optional structured context (such as device id and feature vectors) to the generative AI model, and invokes an inference function.

Server receives an output token sequence from the generative AI model, decodes the tokens into a natural-language response text, and stores this text with fields {response_id, prompt_id, response_text} in a response log table.

Output: a response text from the generative AI model that includes at least one countermeasure proposal.

### Step 10

Server parses the generative AI model's response to extract concrete countermeasure content.

Input: response_text from the response log table associated with a particular response_id.

Server applies natural language processing, including sentence segmentation, part-of-speech tagging, and pattern matching, to identify phrases that correspond to actionable items, such as specific parameter changes, component checks, or maintenance tasks.

Server for each identified action creates a structured action record with fields {action_id, response_id, device_id, action_type, parameter_values, estimated_duration, priority}.

Server stores these records in a countermeasure table.

Output: a set of structured countermeasure actions extracted from the generative AI model's response.

### Step 11

Server formulates and solves an optimization problem to schedule countermeasure actions.

Input: action records from the countermeasure table, system constraints from a constraints table (for example, resource availability, allowable downtime windows), and optional production plans from a schedule table.

Server defines decision variables representing whether each action is executed in each discrete time slot within a planning horizon.

Server defines an objective function that minimizes total downtime, cost, or risk, and defines constraints that ensure non-overlapping use of limited resources and adherence to operational restrictions.

Server invokes an optimization solver to compute optimal values of the decision variables and derives an execution order and execution timing for all actions.

Server writes countermeasure plan information with fields {plan_id, action_id, start_time, end_time, assigned_resource} into a plan table.

Output: an optimized countermeasure plan that specifies when and how each action is to be executed.

### Step 12

Server adjusts user interface presentation based on the countermeasure plan and user emotion.

Input: plan information from the plan table and emotion state information from the emotion table.

Server determines which actions are critical and which are informational, and constructs a presentation layout that highlights critical tasks.

Server reduces the number of concurrently visible elements and uses simplified labels when the emotion state indicates stress, or presents more detailed charts and reasoning when the emotion state indicates calmness.

Server sends the presentation configuration and relevant data subsets to Terminal.

Output: a user interface specification that Tailors the display to User and the current plan.

### Step 13

Terminal presents the countermeasure plan and analysis results to User.

Input: user interface specification and associated data received from Server.

Terminal renders task lists, Gantt charts, and status indicators on its display unit, including action descriptions, start and end times, and assigned resources.

Terminal also displays emotion indicators or hints (for example, “simplified mode” when the user is stressed) and may provide interactive buttons for acknowledging or modifying tasks.

Output: a visual and interactive display that allows User to understand and interact with the countermeasure plan.

### Step 14

User reviews and optionally modifies proposed countermeasure actions.

Input: the displayed plan and analysis results visible on Terminal.

User reads the recommended actions, checks feasibility, and may approve or adjust actions (for example, by changing timing or omitting certain tasks) through input operations such as clicking, tapping, or entering comments.

Terminal captures the user modifications and sends the updated plan parameters back to Server.

Output: a confirmed or modified plan reflecting User's adjustments.

### Step 15

Server logs execution and outcome data for feedback and learning.

Input: confirmed plan information from the plan table, status updates from execution systems or user confirmations, and post-execution sensor data from the integrated data table.

Server records when each action actually starts and ends and associates outcome metrics (for example, subsequent anomaly indices, defect rates, or downtime) with the corresponding plan_id and action id.

Server generates labeled records indicating whether each countermeasure action was effective, partially effective, or ineffective, and writes them to a result table.

Output: a historical data set of executed countermeasures and their outcomes, used for retraining the generative AI model and the anomaly detection models.

### Step 16

Server updates machine learning models using accumulated learning information.

Input: past operation case data from the integrated data table, anomaly case data from the anomaly table, and countermeasure execution result data from the result table.

Server constructs training batches for the anomaly detection model and updates its parameters by minimizing an error function (for example, reconstruction error or classification loss) through gradient-based optimization.

Server constructs fine-tuning examples for the generative AI model, including prompt sentences and desired target responses that emphasize effective countermeasures and penalize ineffective ones, and performs additional gradient descent steps to update the model weights.

Server stores updated model parameters in the storage unit and records metadata describing the training session.

Output: updated anomaly detection and generative AI models with improved performance for future cycles.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent.

Moreover, when the processing of each of the units mentioned above is performed by an AI, this processing is partly or entirely performed by the AI, however there is no limitation to such examples.

Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

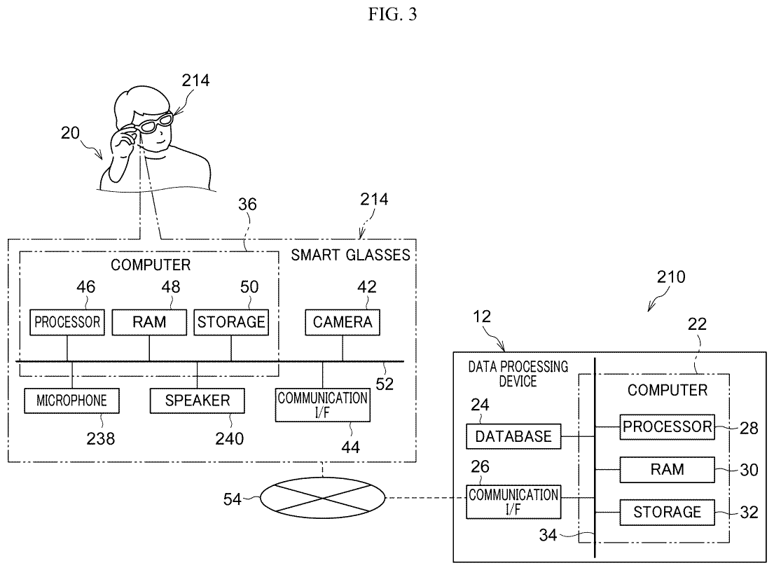

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

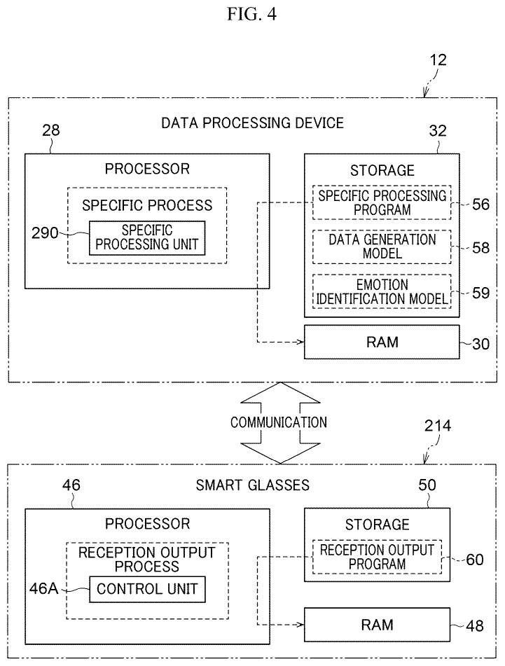

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

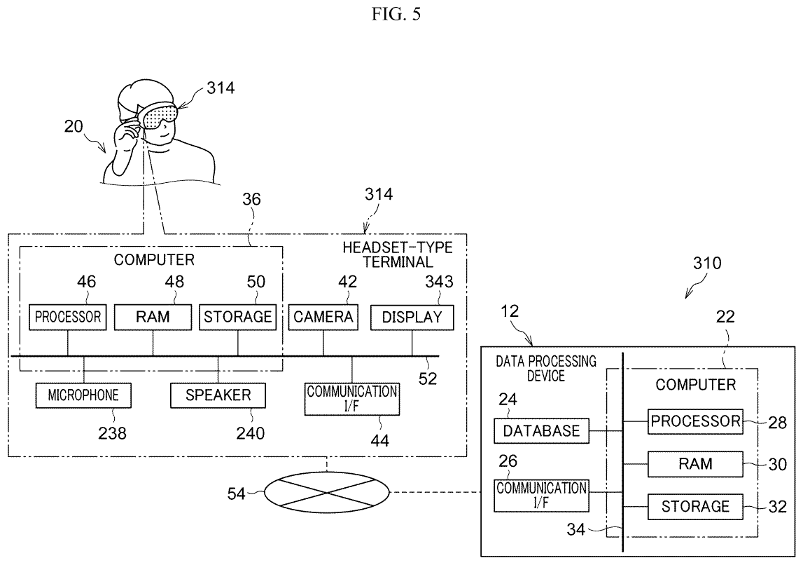

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

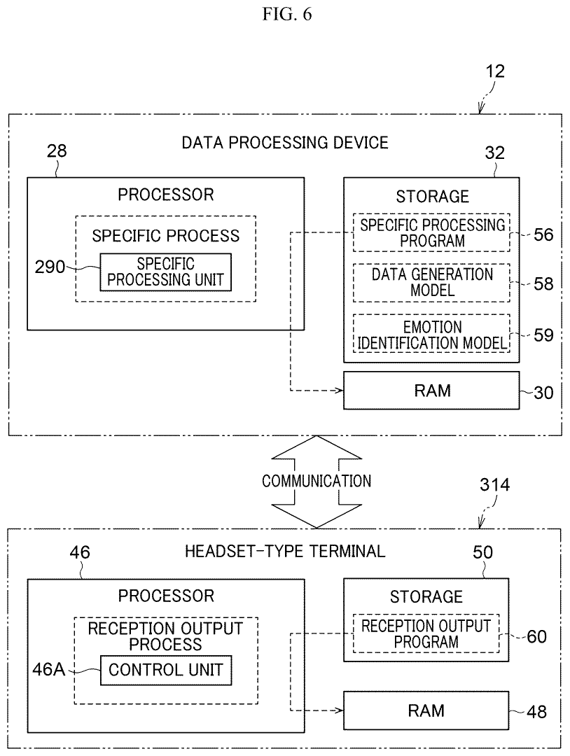

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

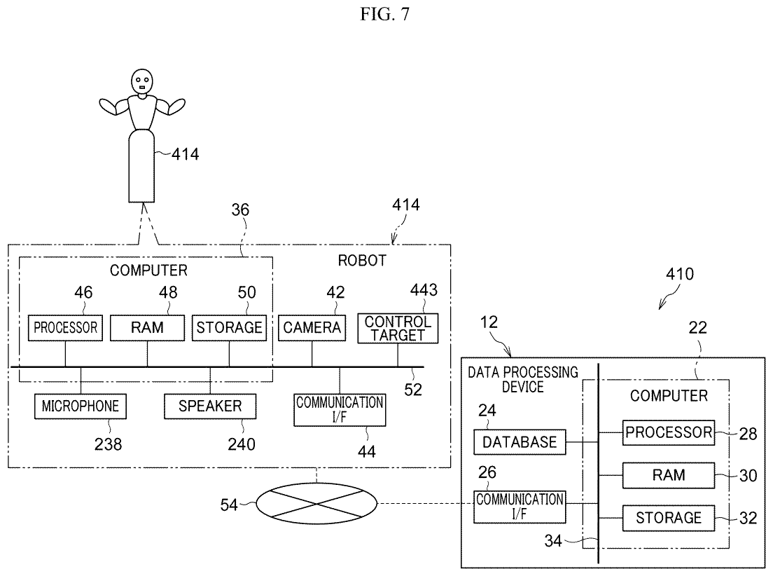

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

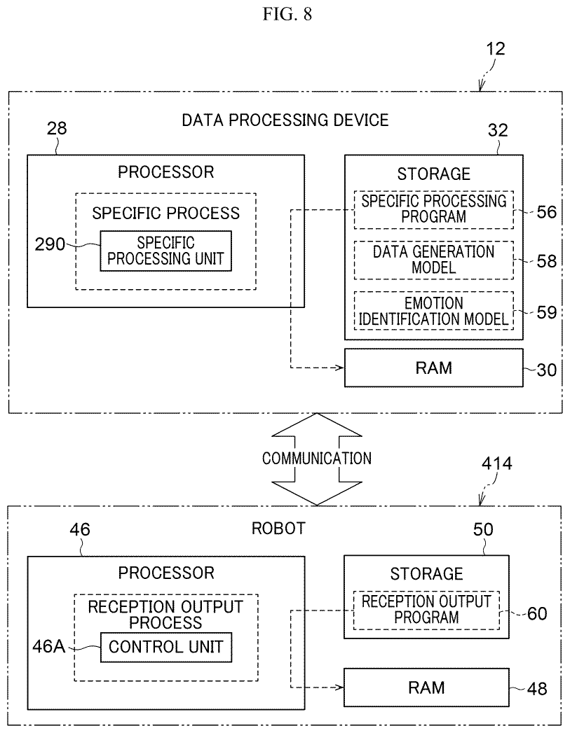

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

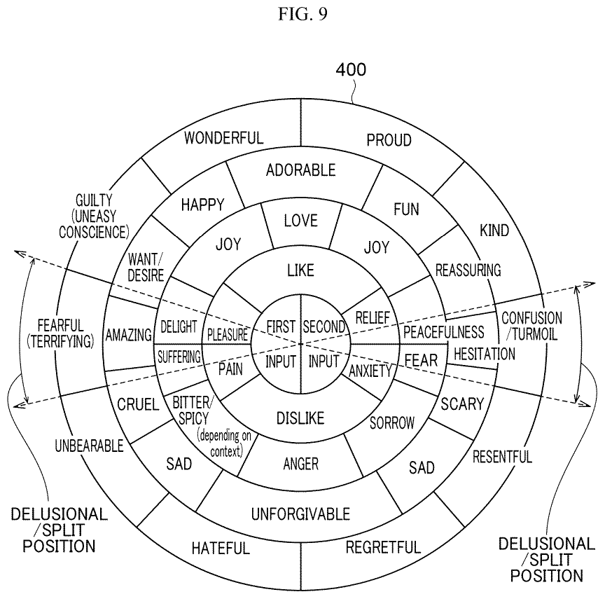

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

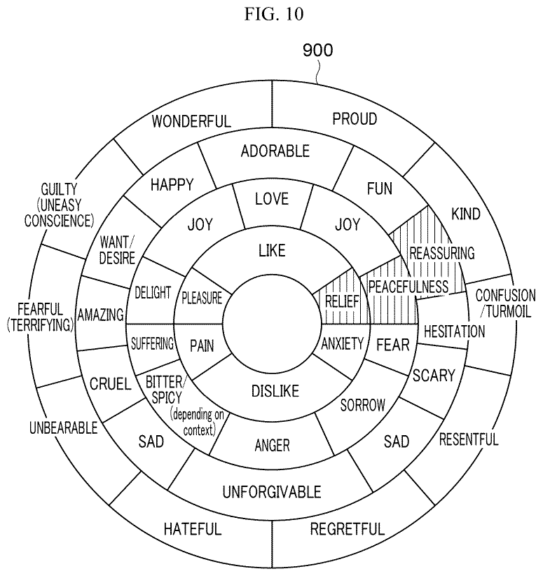

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor, wherein the processor is configured to receive information input from a user;

visualize the received information as a graphical representation;

record and track temporal changes of the received information and measurement values based on the received information;

detect an anomaly by performing statistical processing and learning processing on a data set including the temporal changes;

extract context information related to the detected anomaly and specify a cause of the anomaly based on integrated information including the context information;

set, as changeable parameters, control variables and operation conditions related to the specified cause, and perform a simulation process that simulates behavior when the parameters are varied;

construct an optimization problem by defining an objective function and constraint conditions using a result of the simulation process, and calculate a countermeasure plan by solving the optimization problem;

generate explanation information that presents the countermeasure plan in a human-interpretable form and present the explanation information to the user;

estimate an emotional state of the user based on at least one of voice information, image information, and operation information, and adjust at least one of content and a presentation method of the explanation information in accordance with the emotional state;

store, as a history, anomaly detection results, cause specification results, countermeasure plans, and evaluation information received from the user, and update at least one of the anomaly detection, the cause specification, and the calculation of the countermeasure plan based on the history;

generate a prompt sentence including summary information of the anomaly detection results, the cause specification results, and the countermeasure plans as input information, and input the prompt sentence to a generative artificial intelligence model to obtain a natural language explanation and an additional proposal; and integrate natural language output obtained from the generative artificial intelligence model into the explanation information, present the integrated explanation information to the user, and reflect feedback received from the user in at least one of generation of the prompt sentence and calculation of the countermeasure plan.

### Supplementary 2

The system according to supplementary 1,
wherein the processor is configured to
supply, to the generative artificial intelligence model, at least one of domain knowledge information, operation history information, and evaluation information as learning data, and execute a learning process to improve quality of natural language output in response to the prompt sentence.

### Supplementary 3

The system according to supplementary 1,
wherein the processor is configured to
construct a learning model in which presence or degree of the anomaly is used as an objective variable and at least one of operation conditions, environment conditions, and resource allocation conditions is used as an explanatory variable, and dynamically update at least one parameter of the simulation process and the optimization problem based on the learning model so as to improve accuracy of the countermeasure plan.

### Application Example 1

### Supplementary 1

A system comprising a processor,
wherein the processor is configured to
receive information input by a user,
acquire operation information from detection devices and information storage devices installed in production equipment,
normalize the acquired operation information and the information input by the user and store the normalized information as time-series information,
detect an abnormal operation state on the basis of the stored time-series information by performing statistical processing or machine learning processing,
analyze a correlation or a causal relationship between time-series information in which the abnormal operation state is detected and other operation information, and extract and rank candidate causes of the abnormal operation state,
obtain countermeasure contents corresponding to the candidate causes from knowledge information, evaluate influences of a plurality of the countermeasure contents by simulation processing or optimization processing, and generate a recommended countermeasure plan,
convert the acquired operation information, the detected abnormal operation state, the extracted candidate causes, and the generated recommended countermeasure plan into visual information and output the visual information to a display device,
estimate an emotional state of the user from an input history or response content of the user and adjust content or format of presentation of the recommended countermeasure plan according to the emotional state, and
receive, from the user, a prompt sentence described in natural language, generate context information including the prompt sentence, the operation information, the abnormal operation state, the candidate causes, and the recommended countermeasure plan, input the context information to a generative artificial intelligence model to cause the generative artificial intelligence model to generate a natural-language explanation and an additional countermeasure proposal, and present a result of the natural-language explanation and the additional countermeasure proposal to the user.

### Supplementary 2

The system according to supplementary 1,
wherein the processor is configured to provide the generative artificial intelligence model with knowledge information concerning the operation information, abnormal cases, causes, and countermeasure plans as learning data and update model setting information so as to improve expertise and consistency of the natural-language explanation and the additional countermeasure proposal.

### Supplementary 3

The system according to supplementary 1,
wherein the processor is configured to generate feature quantities from the time-series information, construct an anomaly detection model and an evaluation model for the feature quantities by a machine learning algorithm, and sequentially update a determination of presence or absence of the abnormal operation state and an evaluation result of the countermeasure contents by using the constructed models.

### Example 2

### Supplementary 1

A system comprising a processor,
wherein the processor is configured to
receive, via a terminal, information input by a user;
store the information in a data storage device;
perform preprocessing on the stored information, the preprocessing including at least missing-value processing, normalization processing, and outlier processing;
execute, by using an artificial intelligence engine that runs a machine learning algorithm, prediction processing and anomaly detection processing on the preprocessed information;
aggregate prediction results and anomaly detection results obtained by the artificial intelligence engine, and structure them as summary information and statistical information;
receive, via the terminal, a prompt sentence input by the user in natural language;
generate input data by combining the prompt sentence with the structured summary information and statistical information, and provide the input data to a generative AI model;
cause the generative AI model to generate, on the basis of the input data, an analysis result in natural language including at least causes of anomalies and candidate countermeasures;
associate the generated analysis result with the prediction results and the anomaly detection results, and format them as report information to generate display data including a visual representation;
transmit the display data to the terminal so that the display data is presented on the terminal in a form including at least one of a graph and a chart; and
estimate an emotional state of the user on the basis of the information input by the user and behavior information acquired from the terminal, and control at least one of the prompt sentence and content of presentation of the analysis result in accordance with the emotional state.

### Supplementary 2

The system according to supplementary 1,
wherein the processor is configured to
sequentially supply, to the generative AI model, the prediction results, the anomaly detection results, and a correspondence between past prompt sentences and generated responses as learning data, and
to provide, by reinforcement learning or fine-tuning learning, domain-specific knowledge, experience, and skills related to business management to the generative AI model.

### Supplementary 3

The system according to supplementary 1,
wherein the processor is configured to
apply a machine learning algorithm, when the artificial intelligence engine formulates the candidate countermeasures, by using, as learning data, historical data stored in the data storage device and past candidate countermeasures generated by the generative AI model together with evaluation results thereof, and calculate an evaluation index regarding effectiveness of the candidate countermeasures so as to improve accuracy of the candidate countermeasures.

### Application Example 2

### Supplementary 1

A system comprising a processor,
wherein the processor is configured to
receive user input information and operation information obtained from observation devices, and integrate the information in a time-series manner and store the integrated information in a storage unit,
generate feature values based on the integrated information and convert the feature values into visual representations, and control a display unit to present the visual representations,
track temporal changes of the feature values, calculate an anomaly index, and detect an anomaly in the information based on the anomaly index,
extract candidate causes of the anomaly by performing statistical analysis or causal analysis based on the anomaly index and the integrated information, and specify cause information,
generate a prompt sentence in natural language based on the cause information and the integrated information, input the prompt sentence into a generative artificial intelligence model, and acquire a response including a countermeasure proposal from the generative artificial intelligence model,
extract concrete countermeasure content from the response, perform an optimization calculation to determine at least one of an execution order and an execution timing of the countermeasure content, and output countermeasure plan information,
analyze emotion-related data obtained from an imaging device and a sound acquisition device to recognize a user emotion, generate emotion state information, and reflect the emotion state information in at least one of the prompt sentence and the countermeasure plan information so as to adjust at least one of the countermeasure plan information and a user interface presentation according to the user emotion.

### Supplementary 2

The system according to supplementary 1,
wherein the processor is configured to provide the generative artificial intelligence model with learning information including past operation case data, anomaly case data, and countermeasure execution result data, and to perform learning control to continuously update output accuracy of the generative artificial intelligence model based on the learning information.

### Supplementary 3

The system according to supplementary 1,
wherein the processor is configured to apply a machine learning algorithm in detecting the anomaly and determining the countermeasure plan information, to generate prediction information, and to perform integrated reasoning that corrects the countermeasure plan information by integrating the response acquired from the generative artificial intelligence model with the prediction information generated by the machine learning algorithm.

What is claimed is:

1. A system comprising:
circuitry configured to
receive, via a packet-switched network, time-series sensor data from a plurality of data acquisition sources,
generate, from the time-series sensor data, a multidimensional feature vector by computing statistical measures over sliding temporal windows,
apply a trained inference model to the multidimensional feature vector to compute a deviation score that quantifies divergence of the multidimensional feature vector from a reference distribution,
determine, based on the deviation score exceeding a threshold, that a deviation condition exists in the time-series sensor data,
construct, responsive to the deviation condition, a structured input sequence that encodes at least the deviation score, the multidimensional feature vector, and correlation factor data identifying contributing variables, and transmit, via the packet-switched network, the structured input sequence to a generative neural network model,
receive, via the packet-switched network, from the generative neural network model, inference output data comprising a natural-language analysis and structured remediation parameters, and
transmit, via the packet-switched network, display data derived from the inference output data to a terminal device.

2. The system according to claim 1, wherein the circuitry is further configured to:
process multi-modal input signals received from the terminal device to compute an affective state indicator, and
adjust at least one of content granularity and presentation format of the display data based on the affective state indicator.

3. The system according to claim 2, wherein the multi-modal input signals comprise at least two of audio feature data extracted from a microphone signal, facial landmark data extracted from an imaging sensor signal, and interaction timing data derived from user input events at the terminal device.

4. The system according to claim 3, wherein the affective state indicator is computed by a trained classifier that receives a concatenated feature representation of the audio feature data, the facial landmark data, and the interaction timing data, and outputs a classification label corresponding to an estimated cognitive load level of a user.

5. The system according to claim 4, wherein the circuitry adjusts the content granularity by selecting between a detailed explanation mode and a condensed summary mode for the natural-language analysis based on the estimated cognitive load level.

6. The system according to claim 1, wherein the trained inference model comprises an autoencoder neural network having an encoder layer, at least one hidden layer, and a decoder layer, and the deviation score comprises a reconstruction error computed as a difference between an input feature vector and a reconstructed feature vector output by the decoder layer.

7. The system according to claim 6, wherein the circuitry is further configured to train the autoencoder neural network by:
providing historical multidimensional feature vectors representing reference operating conditions as training inputs, and
updating weight parameters of the autoencoder neural network by minimizing a reconstruction loss function using gradient-based optimization.

8. The system according to claim 1, wherein the statistical measures comprise at least a rolling mean, a rolling standard deviation, and a first-order temporal difference computed for each channel of the time-series sensor data within each sliding temporal window.

9. The system according to claim 8, wherein the circuitry further computes frequency-domain features from at least one channel of the time-series sensor data using a discrete Fourier transform, and incorporates the frequency-domain features into the multidimensional feature vector.

10. The system according to claim 1, wherein the correlation factor data is determined by:
computing correlation coefficients between the deviation score and individual feature components of the multidimensional feature vector across a temporal neighborhood surrounding the deviation condition, and
ranking contributing variables based on magnitude of the correlation coefficients.

11. The system according to claim 10, wherein the circuitry further performs a time-lagged causal analysis on feature sequences to evaluate whether past values of a candidate variable improve prediction of current deviation scores, and incorporates results of the time-lagged causal analysis into the correlation factor data.

12. The system according to claim 1, wherein the circuitry is further configured to:
parse the inference output data to extract discrete action items from the natural-language analysis,
formulate an optimization problem defining decision variables representing execution parameters of the discrete action items, an objective function, and constraint conditions, and
solve the optimization problem to generate a scheduled execution plan specifying at least one of an execution order and execution timing for the discrete action items.

13. The system according to claim 12, wherein the circuitry is further configured to execute a simulation process that models system behavior under a plurality of parameter configurations derived from the correlation factor data, and wherein a result of the simulation process is used to define the objective function.

14. The system according to claim 13, wherein the simulation process comprises a discrete-event simulation that processes events in chronological order, updates system state variables including queue lengths and throughput metrics, and outputs performance metrics for each parameter configuration.

15. The system according to claim 12, wherein the constraint conditions encode at least resource availability constraints, safety bound constraints, and user-specified operational restrictions received from the terminal device.

16. The system according to claim 1, wherein the circuitry is further configured to:
store a history comprising the deviation score, the correlation factor data, the inference output data, and evaluation feedback received from a user via the terminal device, and
update at least one of parameters of the trained inference model and a prompt template used to construct the structured input sequence based on the history.

17. The system according to claim 16, wherein updating the prompt template comprises adjusting weighting of the correlation factor data and the deviation score within the structured input sequence based on effectiveness metrics derived from the evaluation feedback.

18. A system comprising:
circuitry configured to
receive, via a packet-switched network, sequential data records each comprising a timestamp and at least one measurement value from a data acquisition source,
normalize the sequential data records into a unified temporal schema and store normalized records in a time-series data structure,
compute, from the normalized records, feature vectors over sliding temporal windows,
apply a trained anomaly detection model to the feature vectors to identify records that deviate from a learned reference pattern,
construct a structured prompt representation incorporating at least a summary of identified deviations and ranked contributing factors, and transmit, via the packet-switched network, the structured prompt representation to a generative neural network model, and
receive, via the packet-switched network, generated text data from the generative neural network model and transmit, via the packet-switched network, display output data derived from the generated text data to a terminal device.

19. The system according to claim 18, wherein the circuitry is further configured to:
extract, from the generated text data, discrete remediation parameters by applying natural language parsing, and
perform an optimization calculation on the discrete remediation parameters to determine an execution schedule that satisfies resource constraints and minimizes a cost objective.

20. A method performed by a system comprising circuitry, the method comprising:
receiving, via a packet-switched network, time-series sensor data from a plurality of data acquisition sources,
generating, from the time-series sensor data, a multidimensional feature vector by computing statistical measures over sliding temporal windows,
applying a trained inference model to the multidimensional feature vector to compute a deviation score that quantifies divergence of the multidimensional feature vector from a reference distribution,
determining, based on the deviation score exceeding a threshold, that a deviation condition exists in the time-series sensor data,
constructing, responsive to the deviation condition, a structured input sequence that encodes at least the deviation score, the multidimensional feature vector, and correlation factor data identifying contributing variables, and transmitting, via the packet-switched network, the structured input sequence to a generative neural network model,
receiving, via the packet-switched network, from the generative neural network model, inference output data comprising a natural-language analysis and structured remediation parameters, and
transmitting, via the packet-switched network, display data derived from the inference output data to a terminal device.
